(19) United States
(12) Patent Application Publication
(10) Pub. No.: US 2004/0035846 A1
(43) Pub. Date: Feb. 26, 2004

(54) Ceramic heater for semiconductor manufacturing and inspecting equipment

(76) Inventors: Yasuji Hiramatsu, Ibi-gun, Gifu (JP); Yasutaka Ito, Ibi-gun, Gifu (JP); Atsushi Ito, Ibi-gun, Gifu (JP); Satoru Kariya, Ibi-gun, Gifu (JP)

Correspondence Address: KENYON & KENYON, 1500 K STREET, N.W., SUITE 700, WASHINGTON, DC, 20005, US

(21) Appl. No.: 10/380,327

(22) PCT Filed: Aug. 30, 2001
(86) PCT No.: PCT/JP01/07456

(30) Foreign Application Priority Data
Sep. 13, 2000 (JP) 2000-278773

(51) Int. Cl. H05B 3/68; H05B 3/08

(52) U.S. Cl. 219/444.1; 219/468.1; 219/541

(57) ABSTRACT

An object of the present invention is to provide a ceramic heater for a semiconductor producing/examining device in which the temperature of the whole of its wafer heating face becomes even and by which a semiconductor wafer and the like can be evenly heated. The ceramic heater for a semiconductor producing/examining device according to the present invention comprises a resistance heating element formed on a surface of a ceramic substrate or inside the ceramic substrate, wherein the dispersion of the resistance value of the resistance heating element to the average resistance value thereof is 25% or less.

### TECHNICAL FIELD

The present invention relates to a ceramic heater for a semiconductor producing/examining device used in the semiconductor industry.

### BACKGROUND ART

A semiconductor product is produced through the step of forming a photosensitive resin as an etching resist on a semiconductor wafer and etching the semiconductor wafer, and other steps.

This photosensitive resin is in a liquid form, and is applied onto a surface of a semiconductor wafer, using a spin coater and the like. The resin must be dried after the application in order to scatter the solvent and so on. Thus, the semiconductor wafer to which the resin is applied is placed on a heater and then heated.

Conventionally, as a heater, made of metal, which is used for such a purpose, a heater wherein resistance heating elements are arranged on the rear face of an aluminum plate has been adopted.

However, such a metal heater has the following problems.

First, the thickness of the heater plate must be as thick as about 15 mm since the heater is made of metal. This is because in a thin metal plate a warp, a strain and the like are generated on the basis of thermal expansion thereof resulting from heating so that a silicon wafer placed on the metal plate is damaged or inclined. However, if the thickness of the heater plate is made thick, a problem that the heater becomes heavy and bulky arises.

Heating temperature is controlled by changing amount of voltage or electric current applied to the resistance heating elements. However, since the metal plate is thick, the temperature of the heater plate does not follow the change in the voltage or electric current amount promptly. Thus, a problem that the temperature is not easily controlled is caused.

Thus, JP Kokai Hei 9-306642, JP Kokai Hei 4-324276 or the like discloses a ceramic heater wherein AlN, which is a non-oxide ceramic having a high thermal conductivity and a large strength, is used as a substrate, and resistance heating elements are formed on a surface of this AlN substrate or inside the substrate.

JP Kokai Hei 11-40330 or the like discloses a ceramic heater wherein a nitride ceramic or carbide ceramic having a high thermal conductivity and a large strength is used as a substrate, and resistance heating elements formed by sintering metal particles are provided on a surface of a plate formed body of this ceramic (ceramic substrate).

Examples of the method for forming resistance heating elements when such a ceramic heater is produced include the following methods.

First, a ceramic substrate having a predetermined shape is produced. Thereafter, in the case where resistance heating elements are formed by a coating method, such a manner as screen printing is subsequently used to form a conductor containing paste layer for a heating element pattern and then the layer is heated and fired to form the resistance heating elements.

In the case where a physical vapor deposition method, such as sputtering, or a plating method is used to form resistance heating elements, a metal layer is formed in a predetermined region of a ceramic substrate by this method and, subsequently, an etching resist is formed to cover a portion for a pattern of the heating elements. Thereafter, etching treatment is applied to the resultant so as to form the resistance heating elements having the predetermined pattern.

Portions other than the heating element pattern are firstly coated with a resin and the like and, then, the above-mentioned treatment is applied to the resultant, whereby resistance heating elements having the predetermined pattern can also be formed on a surface of the ceramic substrate by the single treatment.

### SUMMARY OF THE INVENTION

In the method of spattering, plating and the like, however, in order to form resistance heating elements having a predetermined pattern, it is necessary to use the manner of photolithography to form an etching resist, a plating resist and the like on a surface of a ceramic substrate although a minute and precise pattern can be formed. As a result, this method has a problem of high costs.

On the other hand, in the method using a conductor containing paste, resistance heating elements can be formed at relatively low costs by using such a manner as screen printing, as described above; however, when it is intended to form a minute and precise pattern, a short circuit or the like is caused by a trivial mistake when the pattern is printed. Thus, this method has a problem that resistance heating elements having a precise pattern cannot be easily formed.

Dependently on the heating element pattern, the thickness or the width of the printed body is dispersed so that the resistance value is dispersed. Therefore, when it is intended to use a ceramic heater wherein resistance heating elements having such a heating element pattern are formed to heat a semiconductor wafer and the like, the temperature in the whole of the wafer heating face does not become uniform although the density of the heating element pattern is even as a whole. As a result, there is a problem that a temperature difference is generated between the central portion and the peripheral portion of the heated semiconductor wafer.

The present invention has been made in light of the above-mentioned problems. An object thereof is to provide a ceramic heater for a semiconductor producing/examining device making it possible to suppress dispersion of temperature of its heating face at stationary time or temperature-rising transitional time by suppressing dispersion of a resistance heating element to a predetermined value.

That is, a first aspect of the present invention is a ceramic heater for a semiconductor producing/examining device, comprising: ceramic substrate; and a resistance heating element formed on a surface of the above-mentioned ceramic substrate or inside the above-mentioned ceramic substrate, wherein the dispersion of the resistance value of the above-mentioned resistance heating element to the average resistance value thereof is 25% or less.

About the average resistance value, the resistance heating element (or each of resistance heating elements) is finely divided, and the resistance values of the divided regions are actually measured. The dispersion is calculated from the average value of this actually-measured resistance values and the difference between the maximum of the actually-measured resistance values and the minimum thereof.

As disclosed in, for example, JP Kokai Hei 9-306642, JP Kokai Hei 4-324276 and the like, when a resistance heating element having a concentric circular pattern or a spiral pattern is formed, the thickness thereof is dispersed between regions perpendicular to the direction along which the printing thereof is performed and regions parallel to the direction. This causes a change in the resistance value so that a dispersion is generated in the temperature in the heating face.

In a resistance heating element 42 having a spiral pattern, illustrated in FIG. 1, the thickness of a pattern portion in a region A tends to be large while the thickness of a pattern portion in a region B tends to be small. Accordingly, in this resistance heating element 42, the resistance value in the portion of the region A is low and the resistance value in the portion of the region B is high. Thus, the amount of generated heat is dispersed.

However, when a repeated pattern of a winding line is used, the direction in which the pattern is printed changes dependently on the position thereof. Therefore, the dispersion of the thickness decreases.

As described above, in the first aspect of the present invention, the temperature dispersion of the heating face can be suppressed at stationary time or temperature-rising transitional time by combining a repeated pattern of a winding line with another pattern to form a resistance heating element and, then, adjusting the dispersion of the resistance value of the resistance heating element to 25% or less.

The resistance heating element which constitutes the ceramic heater for a semiconductor producing/examining device of the first aspect of the present invention desirably comprises a resistance heating element having a repeated pattern of a winding line, or comprises a resistance heating element formed by combining a concentric circular pattern or a spiral pattern with a repeated pattern of a winding line.

In the resistance heating element, a resistance heating element of a repeated pattern of a winding line is desirably formed in the peripheral portion of the ceramic substrate.

This is for suppressing the dispersion of the resistance value of the resistance heating element to the average resistance value thereof to 25% or less.

Besides the method of mixing the repeated pattern of the winding line to form the resistance heating element, the thickness thereof may be adjusted by belt sander treatment, thereby adjusting the dispersion of the resistance value of the resistance heating element to 25% or less.

A second aspect of the present invention is a ceramic heater for a semiconductor producing/examining device, comprising: a ceramic substrate; and a resistance heating element formed on the above-mentioned ceramic substrate, wherein a gutter or an incision is formed in the resistance heating element, and the gutter has a depth of 20% or more of the thickness of the resistance heating element.

Since the gutter formed by trimming has a depth of 20% or more of the thickness of the resistance heating element, the change amount of the resistance value based on the trimming is large. Thus, the resistance value can be easily controlled. If the depth is less than 20% of the resistance heating element thickness, the resistance hardly changes so that the resistance value cannot be easily controlled.

The gutter more desirably has a depth of 50% or more of the resistance heating element thickness. The gutter still more desirably reaches the surface of the ceramic substrate. In the case where the gutter reaching the surface of the ceramic substrate is formed, the resistance heating element is completely separated by the formed gutter so that the length of the trim completely links with the change amount of the resistance value. Therefore, the resistance value can be more easily controlled.

In the case where the resistance heating element remains in the bottom of the gutter formed by the trimming, the resistance value changes due to the remaining amount. Therefore, the trimming length does not precisely link with the change amount of the resistance value. As a result, the dispersion of the resistance value becomes large. In the case where the resistance heating element remains in the bottom of the gutter formed by the trimming, oxidation resistance of the remaining resistance heating element also becomes poor so that the resistance value changes easily with the passage of time. However, if the trimmed gutter reaches the bottom of the ceramic substrate, such a problem is not caused.

The gutter formed by the trimming is desirably stopped at the surface of the ceramic substrate or at a depth within 30% of the thickness of the ceramic substrate. If the depth exceeds 30%, the strength of the ceramic substrate drops so that the ceramic substrate warps easily.

The width of the heating element pattern is desirably 0.5 mm or more. If the width is less than 0.5 mm, it is difficult to perform the trimming in parallel to the direction in which electric current flows in the resistance heating element.

A third aspect of the present invention is a ceramic heater for a semiconductor producing/examining device, comprising: a ceramic substrate; and a resistance heating element formed on the above-mentioned ceramic substrate, wherein a gutter or an incision is formed in above-mentioned resistance heating element, and the resistance heating element-formed face of above-mentioned ceramic substrate has a surface roughness of R≦20 μm.

According to the third aspect of the present invention, the resistance value thereof is adjusted; therefore, laser ray is easily reflected when the gutter or the incision is formed in the resistance heating element. Thus, drop in the winding strength of the ceramic substrate or the warp amount thereof can be reduced.

If the resistance heating element-formed face of the ceramic substrate has the surface roughness of Ra>20 μm, laser ray is not easily reflected so that a deep gutter and the like is formed in the ceramic substrate. Consequently, the ceramic substrate warps or the strength thereof drops.

The surface roughness of the substrate is more desirably Ra≦10 μm. This is because the cooling time can be set within almost 120 seconds. If the cooling time exceeds 120 seconds, the productivity may deteriorate.

For example, at the time of cooling the ceramic heater, a fluid, which will be a cooling medium, is blown against the resistance heating element-formed face of the ceramic substrate. If an incision or a gutter is formed at the resistance heating element at this time, turbulence is easily generated. If the surface roughness of the resistance heating element-formed face is large, turbulence is more easily generated so that the fluid having heat remains. As a result, the temperature-dropping speed drops.

As described above, however, by setting the resistance heating element-formed face of the ceramic substrate to have Ra≦20 μm, the generation of turbulence can be reduced. In this way, the temperature-dropping speed can be improved.

The dispersion of the resistance value of the resistance heating element constituting the ceramic heaters for a semiconductor producing/examining device of the second and third aspects of the present invention to the average resistance value thereof is desirably 5% or less.

This is because: even in the case that the resistance heating element is divided into a plurality of circuits and they are controlled, the number of the divided circuits can be decreased so that the control becomes easy. In the case where the dispersion of the resistance value of the resistance heating element is large, it is necessary to divide the circuit finely and vary applied electric power amounts for the respective circuits (channels) to control the temperature. In the present invention, however, no finely dividing is necessary since the dispersion of the resistance value is hardly generated. As a result, the temperature is easily controlled. Furthermore, the controllability becomes high since the dispersion of the resistance value is small. Thus, the temperature in the heating face can be made even at temperature-rising transitional time.

In the second and third aspects of the present invention, a gutter is desirably formed along and in substantially parallel to the direction in which electric current flows in the resistance heating element.

As illustrated in FIG. 2(a), when gutters 120 are formed by trimming along the direction in which electric current flows in a resistance heating element 12 and in substantially parallel to the direction, the resistance value does not locally become large.

Incidentally, it is not necessary that the conduction direction of electric current and the gutter-forming direction are mathematically parallel to each other. As illustrated in FIG. 2(b), a gutter 130 may be formed to be drawn as a curve. As illustrated in FIG. 2(c), a gutter 140 may be formed to be drawn as a line slanted to the conduction direction of electric current. In short, it is sufficient that the gutter-forming direction is parallel to the conduction direction of electric current or the angle between the conduction direction of electric current and the gutter-forming direction is acute.

As illustrated in FIG. 3, in the case where a resistance heating element 22 is trimmed perpendicularly to the direction in which electric current flows in the resistance heating element 22 to form an incision 22a, the resistance value of a portion A of the resistance heating element 22 becomes extremely high so that the resistance heating element 22 is melted by generated heat, as illustrated in FIG. 4. In the present invention, however, such extreme heat is not generated so that the resistance heating element is not damaged by overheating. Furthermore, the resistance value does not rise extremely. Thus, the dispersion of the resistance value can be made to a considerably small value of 5% or less, preferably 1% or less.

The dispersion of the resistance value of the resistance heating element can be made small in this way; therefore, even if the resistance heating element is divided into a plurality of circuits and they are controlled, the number of the divided circuits can be reduced so that the control thereof can be made easy. When the dispersion of the resistance value is large, it is necessary to divide the circuits finely and vary applied electric power amounts for the respective circuits (channels) so as to control the temperature. However, since the dispersion of the resistance value is hardly generated in the present invention, finely dividing becomes unnecessary so that the temperature is easily controlled. Furthermore, the temperature in the heating face can be made even at temperature-rising transitional time.

In the case where trimming is performed by a laser, the laser is radiated onto the surface of the ceramic substrate when the trimming is performed perpendicularly to the direction in which electric current flows in the resistance heating element. Thus, the color of the ceramic substrate changes so that the external appearance thereof becomes poor and the strength of the ceramic drops.

However, by making gutters in substantially parallel to and along the direction in which electric current flows in the resistance heating element as described above, color-changed portions are hidden and additionally excessive thermal energy is not conducted to the ceramic substrate. Thus, a drop in the strength can be prevented.

In the second and third aspects of the present invention, the resistance heating element is formed on the ceramic substrate by using a conductor containing paste comprising metal or of metal and oxide; therefore, the resistance heating element is easily trimmed, in particular, by laser ray. This is because metal is evaporated and removed by laser but ceramic is not removed. Accordingly, it is unnecessary to adjust the output of laser ray, and removal residues are not generated, which are entirely different from laser trimming onto a semiconductor wafer or a printed circuit board. Thus, trimming with high precision can be realized. Neither warp nor remarkable drop in the strength is caused since the ceramic substrate is used.

### BRIEF DESCRIPTION OF THE DRAWINGS

FIG. 1 is an explanatory view which illustrates the direction of print when a resistance heating element of a spiral pattern is produced.

FIGS. 2(a) to 2(c) are perspective views which schematically illustrate resistance heating elements wherein a gutter(s) is(are) formed along the direction in which electric current flows and in substantially parallel thereto by trimming.

FIG. 3 is a perspective view which schematically illustrates a resistance heating element wherein a gutter is formed perpendicularly to the direction in which electric current flows by trimming.

FIG. 4 is a photograph showing a melted resistance heating element.

FIG. 5 is a plan view which schematically illustrates a pattern of resistance heating elements in a ceramic heater of the present invention.

FIG. 6 is a partially enlarged sectional view of the ceramic heater illustrated in FIG. 1.

FIG. 7 is an explanatory view which illustrates the direction of print when a resistance heating element of a repeated pattern of a winding line is produced.

FIG. 8 is a bottom view which schematically illustrates a ceramic heater wherein resistance heating elements in which a spiral pattern is combined with a repeated pattern of a winding line are formed.

FIG. 9 is a bottom view which schematically illustrates a ceramic heater wherein resistance heating elements of a concentric circular pattern are formed.

FIG. 10 is a bottom view which schematically illustrates a ceramic heater wherein resistance heating elements of a repeated pattern of winding lines are formed.

FIG. 11 is a perspective view which illustrates a situation that a resistance heating element is divided into a plurality of regions in order to measure the resistance value.

FIG. 12 is a block diagram which illustrates an outline of a laser trimming device used when a ceramic heater of the present invention is produced.

FIG. 13 is a perspective view which schematically illustrates a table which constitutes the laser trimming device illustrated in FIG. 3.

FIGS. 14(a) to 14(d) are sectional views which illustrate respective steps when resistance heating elements of the present invention are produced.

FIG. 15 is a sectional view which schematically illustrates a ceramic heater unit wherein a ceramic heater of the present invention is housed in a holding case.

FIGS. 16(a) to 16(d) are concerned with gutters having a depth of 30%, 60% and 90% of the thickness of a resistance heating element, respectively, and a gutter reaching a ceramic substrate, and the upper row thereof gives photographs showing external appearances thereof, the middle row thereof gives graphs showing the shape of sections (height and positions), and the lower row gives sectional views in the case where the external appearances in the upper row are cut along the direction of respective arrows.

FIG. 17 is a graph showing the shape (position and height) of a section of a resistance heating element.

Explanation of Symbols

| 4, 34 | bottomed hole |
|---|---|
| 5, 35 | through hole |
| 11, 31, 61 | ceramic substrate |
| 11a | heating face |
| 11b | bottom face |
| 12 (12a to 12g), 32, 42, 52, 62 (62a to 62d): | |
| | resistance heating element |
| 12m | conductor layer (resistance heating element) |
| 13 | table |
| 13a | fitting projection |
| 13b | fixing projection |
| 14 | laser radiation equipment |
| 15 | galvano mirror |
| 17 | control unit |
| 18 | memory unit |
| 19 | calculation unit |
| 20 | input unit |
| 21 | camera |
| 22 | laser ray |
| 30 | ceramic heater |
| 33 | external terminal |
| 36 | lifter pin |
| 39 | semiconductor wafer |

### DETAILED DISCLOSURE OF THE INVENTION

A first aspect of the present invention will be firstly described according to embodiments. However, a ceramic heater for a semiconductor producing/examining device according to the first aspect of the present invention is not limited to this embodiment if the dispersion of the resistance value of its resistance heating element to the average resistance value thereof is 25% or less.

The ceramic heater for a semiconductor producing/examining device according to an embodiment of the first aspect of the present invention comprises: ceramic substrate; and a resistance heating element formed on a surface of the above-mentioned ceramic substrate or inside thereof. The resistance heating element has a repeated pattern of a winding line or the thickness of the resistance heating element is adjusted, and the dispersion of the resistance value of the above-mentioned resistance heating element to the average resistance value thereof is 25% or less.

In the following description, the ceramic heater for a semiconductor producing/examining device may be simply referred to as a ceramic heater.

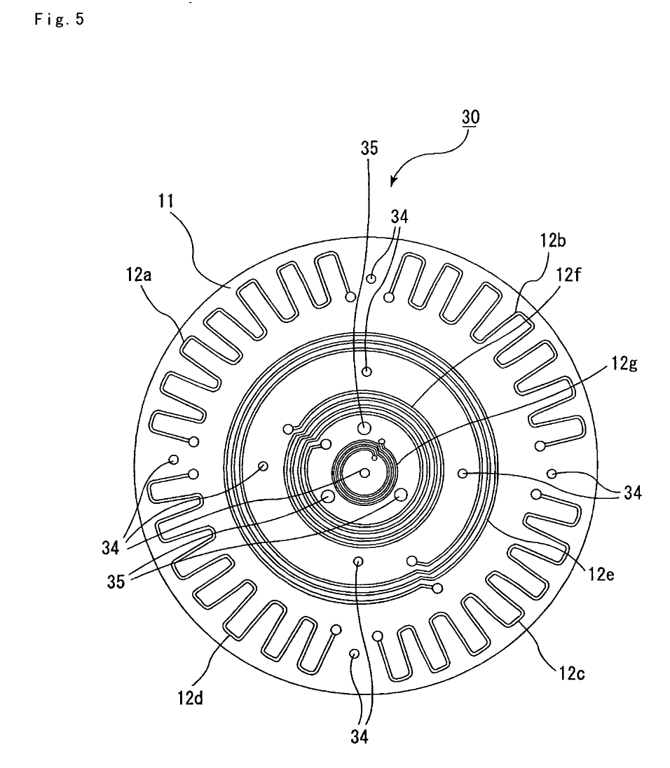

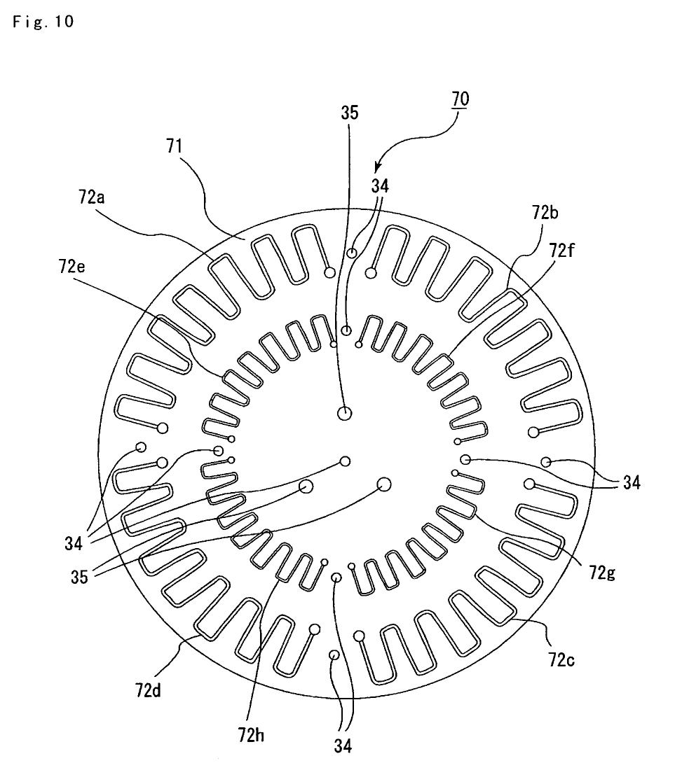

According to the ceramic heater, the resistance heating element has a repeated pattern of a winding line (reference to FIG. 10), or is formed by combining a concentric circular pattern or a spiral pattern with a pattern made of a winding line (reference to FIG. 5). Therefore, a drop in the temperature in the peripheral portion can be suppressed as compared with the case where a resistance heating element having a concentric circular pattern or a spiral pattern is formed on the whole of a ceramic substrate. Thus, the temperature in the whole of the wafer heating face becomes even so that a semiconductor wafer and the like can be evenly heated.

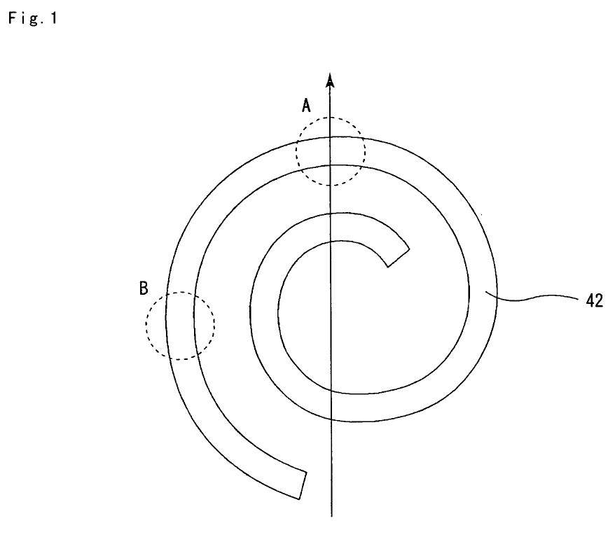

In a pattern made of a winding line or a repeated pattern of a winding line, not only portions parallel to the printing direction but also portions perpendicular to the printing direction are generated due to the existence of winding portions as illustrated in FIG. 7. In the case where a resistance heating element is parallel to the printing direction (D portions in FIG. 7, and the B portion in FIG. 1), a squeegee linearly contacts the circumferential portion of an opening in a mask when the resistance heating element is formed. Thus, the opening in the mask is not easily filled with metal particles. On the other hand, in the case where the resistance heating element is perpendicular to the printing direction (C portions in FIG. 7, and the A portion in FIG. 1), a squeegee contacts the circumferential portion of an opening in a mask by plane when the resistance heating element is formed. Thus, the opening in the mask is easily filled with metal particles. Accordingly, in the case where the heating element has both of the portions C perpendicular to the printing direction and the portions D parallel thereto, the mask opening is filled with the metal particles, thus the dispersion of the resistance value can be decreased.

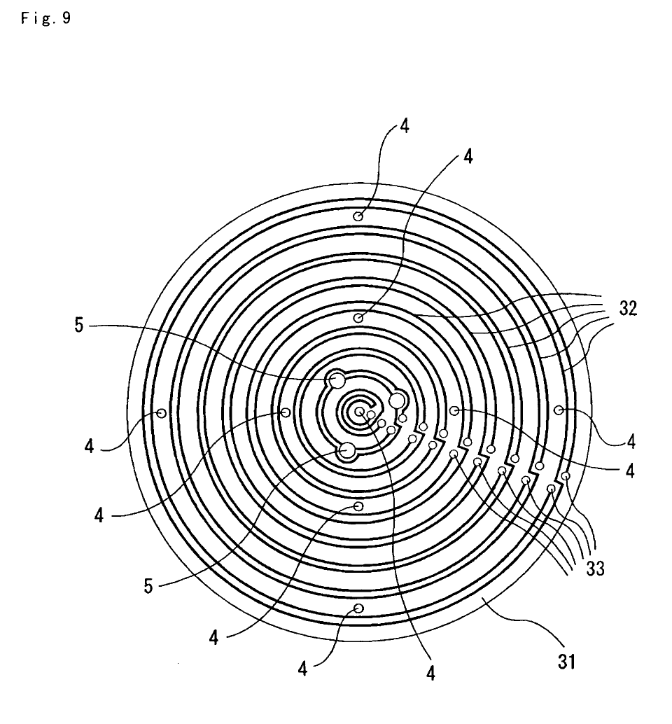

The heating element pattern is not limited to the above-mentioned patterns. For example, the pattern may be in a spiral shape as illustrated in FIG. 9 or FIG. 1. In this case, however, it is necessary to grind the surface of the portions perpendicular to the printing direction with a belt sander and the like to adjust the thickness thereof.

The thickness of the ceramic substrate is desirably 25 mm or less. When the thickness exceeds 25 mm, the heat capacity becomes too large so that it takes much time to conduct heat. Thus, the temperature in the heating face (the face opposite to the resistance heating element-formed face) does not easily become uneven. Thus, it is unnecessary to control the dispersion of the resistance value, as in the first aspect of the present invention. However, the responsibility to applied electric power deteriorates extremely.

The thickness desirably exceeds 1.5 mm and is 5 mm or less. If the thickness is thicker than 5 mm, heat is not easily conducted so that the heating efficiency tends to deteriorate. On the other hand, if the thickness is 1.5 mm or less, a temperature distribution is generated in the heating face since heat conducted in the ceramic substrate does not diffuse sufficiently. Additionally, the strength of the ceramic substrate drops so that it may be damaged.

The diameter of the ceramic substrate desirably exceeds 190 mm, more desirably 200 mm or more for the following reason. That is, as the diameter of the substrate is larger, the temperature in the heating face becomes more uneven. Moreover, a semiconductor wafer having a large diameter can be placed on the substrate having such a large diameter.

In particular, the diameter of the ceramic substrate is desirably 12 inches (300 mm) or more. This size is a size which becomes the main stream of semiconductor wafers in the next generation.

The porosity of the ceramic substrate is desirably 5% or less. This is because, in the ceramic heater having a high porosity, it takes much time to conduct heat since the ceramic substrate has a low thermal conductivity. Thus, the temperature in the heating face (face opposite to resistance heating element-formed face) does not easily become uneven and it is unnecessary to control the dispersion of the resistance value, as in the first aspect of the present invention. However, the responsibility to applied electric power deteriorates extremely.

In the ceramic heater according to the first aspect of the present invention, as the ceramic substrate, a non-oxide ceramic such as a nitride ceramic or a carbide ceramic, or an oxide ceramic is used. An oxide ceramic can also be used as an insulating layer on the surface of the non-oxide ceramic substrate. About the nitride ceramic, the volume resistance value thereof drops easily at high temperatures by the formation of solid-solution with oxygen and the like, and the carbide ceramic has an electric conductivity so far as the ceramic is not made into high purity. By forming the oxide ceramic as the insulating layer, a short circuit is prevented between the circuits at high temperatures or even if it contains impurities. Thus, the temperature controllability can be ensured.

Since the non-oxide ceramic has a high thermal conductivity, the temperature thereof rises or drops promptly and can easily be controlled. Therefore, the non-oxide ceramic is suitable for heaters. However, a dispersion of the temperature, resulting from the pattern of the heating element, is easily generated since the ceramic has a high thermal conductivity. Thus, the non-oxide ceramic is more profitable for the structure of the first aspect of the present invention, as compared with the oxide ceramic.

The surface of the face opposite to the heating face of the ceramic substrate (hereinafter, referred to as a bottom face) preferably has a surface roughness Ra of 20 μm or less.

Examples of the nitride ceramic which constitutes the above-mentioned ceramic substrate include metal nitride ceramics such as aluminum nitride, silicon nitride, boron nitride, titanium nitride and the like.

Examples of the above-mentioned carbide ceramic include metal carbide ceramics such as silicon carbide, zirconium carbide, titanium carbide, tantalum carbide, tungsten carbide and the like.

As the ceramic substrate, an oxide ceramic may be used. Alumina, silica, cordierite, mullite, zirconia, beryllia and the like may be used.

These may be used alone or in combination of two or more thereof.

The substrate made of the non-oxide ceramic, such as the nitride ceramic or the carbide ceramic, has a high thermal conductivity. Thus, the temperature in the heating face of the ceramic substrate can be caused to follow temperature change in the resistance heating element promptly, and the temperature in the heating face can be suitably controlled and further the substrate has a large mechanical strength; therefore, the heater plate does not warp so that a semiconductor wafer placed thereon can be prevented from being damaged.

Among the above-mentioned nitride ceramics, aluminum nitride is most preferred. This is because its thermal conductivity is highest, that is, 180 W/m·K.

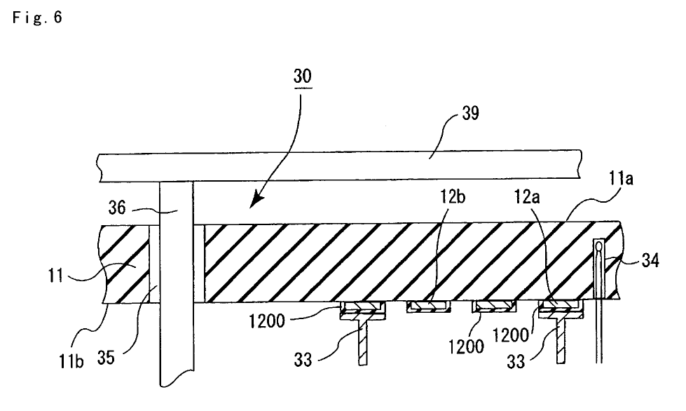

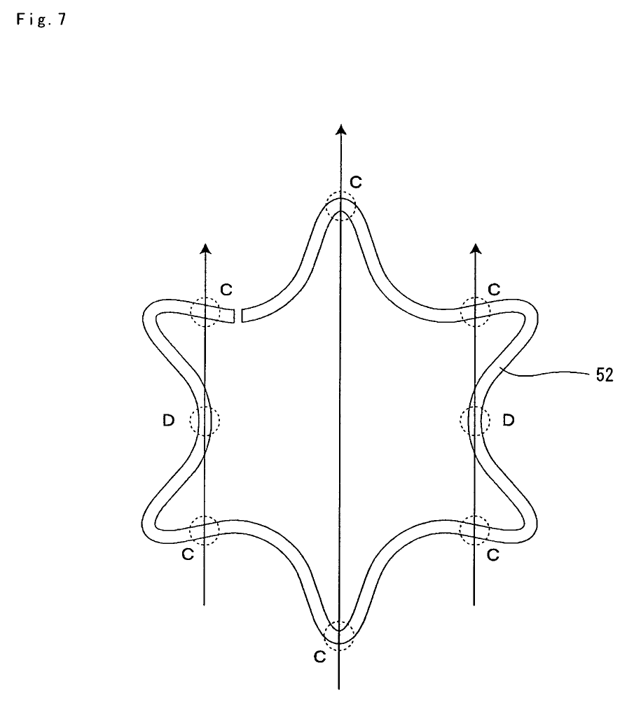

FIG. 5 is a bottom view which schematically illustrates an example of the ceramic heater according to the first aspect of the present invention, and FIG. 6 is a partially enlarged sectional view which illustrates a part thereof.

A ceramic substrate 11 made of a ceramic substrate of a nitride ceramic, a carbide ceramic, an oxide ceramic and the like (hereinafter, referred to as a ceramic substrate made of a nitride and the like) is formed in a disc shape. In order to perform heating in such a manner that the temperature of the whole of the heating face lla of the ceramic substrate 11 becomes even, resistance heating elements 12 (12e to 12g) having a concentric circle-shaped pattern are formed at inner portion on the bottom surface of the ceramic substrate 11. On the other hand, resistance heating elements 12 (12a to 12d) having a repeated pattern of winding lines are formed in the peripheral portion of the ceramic substrate 11.

In the inner resistance heating elements 12a to 12g, two concentric circles near to each other, as one pair, are connected into one line. The resistance heating elements 12 are coated with and protected by a metal covering layer 1200. External terminals 33 are connected to end portions of the resistance heating elements 12 through solder layers (not illustrated). Through holes 35, for letting lifter pins 36 for supporting and carrying a semiconductor wafer 39 pass through, are formed in regions near the center. Furthermore, bottomed holes 34 for inserting temperature measuring elements are formed.

In the ceramic heater 30 according to the first aspect of the present invention, an object to be heated, such as the semiconductor wafer 39 and the like, is placed on the heating face lla of the ceramic substrate 11 in the state where they contact each other, and is heated. Moreover, concave portions, through holes and the like are formed in the ceramic substrate and supporting pins having tips being in a spire form or a semispherical form are inserted and fixed into the concave portions and the like in the state where the tips are slightly projected from the surface of the ceramic substrate. The object to be heated, such as the semiconductor wafer 39, is supported by the supported pins. In this way, the object to be heated may be held in the state where a given interval is kept between the ceramic substrate and the object.

The distance between the heating face and the wafer is preferably from 5 to 5000 μm.

By inserting the lifter pins into the through holes and moving the lifter pins 36 up and down, an object to be heated, such as the semiconductor wafer 39, can be received from a carrier, the object to be heated can be placed on the ceramic substrate 11, or the object to be heated can be heated while being supported.

In the ceramic heater 30 illustrated in FIGS. 5 and 6, the resistance heating elements 12 are provided on the bottom face of the ceramic substrate 11, but may be provided inside the ceramic substrate 11. In the case where the resistance heating elements 12 are provided inside the ceramic substrate 11, the pattern of the resistance heating elements 12 is formed in the same way.

In the ceramic heater 30 according to the first aspect of the present invention, a ceramic such as nitride is used as the material of the ceramic substrate. This is because the ceramic has a thermal coefficient smaller than that of metal, and the ceramic substrate 11 can be made thin and light since the ceramic is not warped or distorted by heating even if the ceramic substrate is made thin.

Since the thermal coefficient of the ceramic substrate 11 is high and the ceramic substrate itself is thin, the surface temperature of the ceramic substrate 11 follows a temperature change in the resistance heating elements promptly. That is, by changing the amount of voltage or electric current to change the temperature of the resistance heating elements, the surface temperature of the ceramic substrate 11 can be suitably controlled.

In the ceramic heater illustrated FIGS. 5 and 6, resistance heating elements 12e to 12g having a spiral shape are formed at the inner portion thereof. However, the resistance heating elements may have a concentric circular shape.

On the other hand, in the peripheral portion, resistance heating elements 12a to 12d of a repeated pattern of winding lines are formed. The degree of the repeatition of the winding of the winding lines may be large per unit length. That is, the number of the windings of the resistance heating elements 12a to 12d illustrated in FIG. 5 may be larger.

FIG. 10 discloses a ceramic heater 70 having a resistance heating element consisting of a repeated pattern of winding lines. Since this ceramic heater 70 has only resistance heating elements 72a to 72h made of the winding line pattern, the dispersion of the resistance value when metal particles are printed can be made small. In the case of a combined pattern of a repeated pattern of winding lines and a spiral or concentric circular pattern, the repeated pattern of the winding lines is desirably formed in the ½ or more of the outer portion of radius from the center. This is because in the outer portion of ½ or more of the radius from the center, the printing direction easily becomes parallel to the arc of the concentric circuits or the spiral so that the dispersion of the resistance value is large.

In the first aspect of the present invention, it is sufficient that at least the peripheral portion has a repeated pattern of a winding line; therefore, a resistance heating element made of a repeated pattern of a winding line may be arranged between inside of the resistance heating element having spiral patterns and/or resistance heating elements made of concentric circular patterns.

The resistance heating element 12 formed on the surface of the ceramic substrate of nitride and the like or inside the ceramic substrate is desirably divided into at least 2 or more circuits, as illustrated in FIG. 5. By the division into the circuits, electric powers applied to the respective circuits are controlled so that the amount of generated heat can be changed. Thus, the temperature in the heated face of the semiconductor can be adjusted.

When the resistance heating elements 12 are formed on the surface of the ceramic substrate 11, the following method is preferred: a method of applying a conductor containing paste which contains metal particles to the surface of the ceramic substrate 11 to form a conductor containing paste layer having a predetermined pattern, and firing this to sinter the metal particles on the surface of the ceramic substrate 11. If the metal particles are melted and adhered to each other and the metal particles and the ceramic are melted and adhered to each other in the sintering of the metal, the sintering is sufficient.

When the resistance heating elements are formed on the surface of the ceramic substrate 11, the thickness of the resistance heating elements is preferably from 1 to 30 μm, more preferably from 1 to 10 μm. When the resistance heating elements are formed inside the ceramic substrate 11, the thickness thereof is preferably from 1 to 50 μm.

When the resistance heating elements are formed on the surface of the ceramic substrate 11, the width of the resistance heating elements is preferably from 0.1 to 20 mm, more preferably from 0.1 to 5 mm. When the resistance heating elements are formed inside the ceramic substrate 11, the width of the resistance heating elements is preferably from 5 to 20 μm.

The resistance value of the resistance heating elements 12 can be changed dependently on their width or thickness. The above-mentioned ranges are however most practical. The resistance value becomes larger as the resistance heating elements become thinner and narrower. The thickness and the width of the resistance heating elements 12 become larger in the case where the resistance heating elements 12 are formed inside the ceramic substrate 11. However, when the resistance heating elements 12 are formed inside, the distance between the heating surface and the resistance heating elements 12 becomes short so that the evenness of the temperature in the surface deteriorates. Thus, it is necessary to make the width of the resistance heating elements themselves large. Since the resistance heating elements 12 are formed inside, it is unnecessary to consider the adhesiveness to nitride ceramic or some other ceramic. Therefore, it is possible to use a high melting point metal such as tungsten or molybdenum, or a carbide of tungsten, molybdenum and the like. Thus, the resistance value can be made high. Therefore, the thickness itself may be made large in order to prevent disconnection and so on. For these reasons, the resistance heating elements 12 are desirably made to have the above-mentioned thickness and width.

The resistance heating elements 12 may have a rectangular section or an elliptical section. They desirably have a flat section. From the flat section, heat is more easily radiated toward the heating face. Thus, a temperature distribution in the heating face is not easily generated.

The aspect ratio (the width of the resistance heating element/the thickness of the resistance heating element) of the section is desirably from 10 to 5000.

Adjustment thereof into this range makes it possible to increase the resistance value of the resistance heating elements 12 and keep the evenness of the temperature in the heating face.

In the case where the thickness of the resistance heating elements 12 is made constant, the amount of heat conducted toward the heating face of the ceramic substrate 11 becomes small if the aspect ratio is smaller than the above-mentioned range. Thus, a heat distribution similar to the pattern of the resistance heating elements 12 is generated in the heating face. On the other hand, if the aspect ratio is too large, the temperature of the portions just above the centers of the resistance heating elements 12 becomes high so that a heat distribution similar to the pattern of the resistance heating elements 12 is generated in the heating face. Accordingly, if temperature distribution is considered, the aspect ratio of the section is preferably from 10 to 5000.

When the resistance heating elements 12 are formed on the surface of the ceramic substrate 11, the aspect ratio is desirably from 10 to 200. When the resistance heating elements 12 are formed inside the ceramic substrate 11, the aspect ratio is desirably from 200 to 5000.

The aspect ratio becomes larger in the case where the resistance heating elements 12 are formed inside the ceramic substrate 11. This is based on the following reason. If the resistance heating elements 12 are provided inside, the distance between the heating face and the resistance heating elements 12 becomes short so that temperature evenness in the surface deteriorates. It is therefore necessary to make the resistance heating elements 12 themselves flat.

The positions where the resistance heating elements 12 are formed to be prejudiced inside the ceramic substrate 11 are desirably positions which are near to the face (bottom face) opposite to the heating face of the ceramic substrate 11 and which have a distance of more than 50% and 99% or less of the distance between the heating face and the bottom face.

If the value is 50% or less, the resistance heating elements are too near to the heating face so that a temperature distribution is generated. Contrarily, if the value exceeds 99%, the ceramic substrate 11 itself warps so that the semiconductor wafer is damaged.

In the case where the resistance heating elements 12 are formed inside the ceramic substrate 11, the resistance heating elements may be constituted by a plurality of layers. In this case, it is desirable that the patterns of the respective layers may be formed to complement them mutually in the state where any part of the resistance heating elements 12 is formed as any one of the layers so that the whole of the patterns is formed over all regions when the resistance heating elements are viewed from above the heating face. Examples of such a structure include a structure having a staggered arrangement.

The resistance heating elements 12 are provided inside the ceramic substrate 11 and the resistance heating elements 12 may be partially exposed.

A conductor containing paste used is not particularly limited. Preferably, the paste contains a resin, a solvent, a thickener and the like, as well as metal particles or a conductive ceramic for ensuring electric conductivity.

The above-mentioned metal particles are preferably made of, for example, a noble metal (gold, silver, platinum or palladium), lead, tungsten, molybdenum, nickel and the like. These may be used alone or in combination of two or more. These metals are not relatively easily oxidized, and have a resistance value sufficient for generating heat.

Examples of the above-mentioned conductive ceramic include carbides of tungsten and molybdenum. These may be used alone or in combination of two or more.

The particle diameter of these metal particles or the conductive ceramic particles is preferably from 0.1 to 100 μm. If the particle diameter is too fine, that is, less than 0.1 μm, they are easily oxidized. On the other hand, if the particle diameter exceeds 100 μm, they are not easily sintered so that the resistance value becomes large while they are not easily printed.

The shape of the metal particles may be spherical or scaly. When these metal particles are used, they may be a mixture of spherical particles and scaly particles.

In the case where the metal particles are scaly or a mixture of spherical particles and scaly particles, metal oxides between the metal particles are easily held and adhesion between the resistance heating elements 12 and the ceramic of the nitride ceramic and the like is made sure. Moreover, the resistance value can be made large. Thus, this case is profitable.

Examples of the resin used in the conductor containing paste include epoxy resin and phenol resin. Examples of the solvent include isopropyl alcohol, butyl carbitol, and diethylene ether monoether. Examples of the thickener includes cellulose and the like.

It is desired to add a metal oxide (glass frit) to the metal particles in the conductor-containing paste and sinter the resistance heating elements, and the metal particles and the metal oxide. By sintering the metal oxide together with the metal particles in this way, the nitride ceramic and the like constituting the ceramic substrate can be closely adhered to the metal particles.

The reason why the adhesiveness to the nitride ceramic and the like by mixing the metal oxide is improved is unclear, but appears to be based on the following. The surface of the metal particles or the surface of the nitride ceramic and the like is slightly oxidized so that an oxidized film is formed. Pieces of this oxidized film are sintered and integrated with each other through the metal oxide so that the metal particles and the nitride ceramic and the like are closely adhered to each other. In the case where the ceramic which constitutes the ceramic substrate is an oxide ceramic, the surface thereof is naturally made of the oxide; therefore, a conductor layer having superior adhesiveness is formed.

A preferred example of the above-mentioned metal oxide is at least one selected from the group consisting of lead oxide, zinc oxide, silica, boron oxide (B₂O₃), alumina, yttria, and titania.

These oxides make it possible to improve adhesiveness between the metal particles and the nitride ceramic or the carbide ceramic without increasing the resistance value of the resistance heating elements 12.

When the total amount of the metal oxides is set to 100 parts by weight, the weight ratio of lead oxide, zinc oxide, silica, boron oxide (B₂O₃), alumina, yttria and titania is as follows: lead oxide: 1 to 10, silica: 1 to 30, boron oxide: 5 to 50, zinc oxide: 20 to 70, alumina: 1 to 10, yttria: 1 to 50 and titania: 1 to 50. The weight ratio is desirably adjusted within the scope that the total thereof is not more than 100 parts by weight. By adjusting the amounts of these oxides within these ranges, in particular, adhesiveness to the nitride ceramic can be improved.

The amount of the metal oxide added in the metal particles is preferably 0.1% or more by weight and less than 10% by weight. When the conductor containing paste having such a structure is used to form the resistance heating elements 12, the area resistivity is preferably from 1 to 50 mΩ/ [symbol] .

If the area resistivity is more than 50 mΩ/ [symbol] , the amount of generated heat becomes too large for applied voltage quantity. In the ceramic substrate 11 wherein the resistance heating elements 12 are provided on the surface of the ceramic substrate, the amount of generated heat is not easily controlled. If the added amount of the metal oxide is 10% or more by weight, the area resistivity exceeds 50 mΩ/ [symbol] so that the amount of generated heat becomes too large. Thus, the temperature is not easily controlled and the evenness of the temperature distribution deteriorates.

If necessary, the area resistivity can be made to 50 mΩ/ [symbol] to 10 Ω/ [symbol] . If the area resistivity is made large, the width of the pattern can be made large. Thus, a problem of disconnection does not arise.

In the case where the resistance heating elements 12 are formed on the surface of the ceramic substrate 11, a metal covering layer 1200 is preferably formed on the surface portion of the resistance heating elements 12. The metal covering layer prevents a change in the resistance value based on oxidization of the inner metal sintered body. The thickness of the formed metal covering layer 1200 is preferably from 0.1 to 10 μm.

The metal used when the metal covering layer 1200 is formed is not particularly limited if the metal is a non-oxidizable metal. Specific examples thereof include gold, silver, palladium, platinum, nickel and the like. These may be used alone or in combination of two or more. Out of these, nickel is preferred. Furthermore, as the covering layer, an inorganic insulating layer of glass and the like, a heat-resistant resin, and the like can be used.

In the resistance heating element 12, a terminal for connection to a power source is necessary. This terminal is fixed to the resistance heating element 12 through solder. Nickel prevents thermal diffusion from the solder. An example of the connecting terminal is an external terminal 33 made of kovar.

In the case where the resistance heating elements 12 are formed inside the ceramic substrate 11, no covering is necessary since the surface of the resistance heating elements is not oxidized. In the case where the resistance heating elements 12 are formed inside the ceramic substrate 11, the resistance heating elements may be partially exposed to the surface. It is allowable that conductor filled through holes for connecting to the resistance heating elements 12 are made in the end portions and external terminals are connected thereto and fixed to the conductor filled through holes.

In the case where the external terminal 33 is connected, an alloy such as silver-lead, lead-tin or bismuth-tin can be used as the solder. The thickness of the solder layer is desirably from 0.1 to 50 μm. This is because this range is a range sufficient for maintaining connection based on the solder.

As illustrated in FIG. 6, through holes 35 may be provided in the ceramic substrate 11, and lifter pins 36 are inserted into the through holes 35, whereby a semiconductor wafer can be delivered to a non-illustrated carrier or the semiconductor wafer can be received from the carrier.

The face opposite to the resistance heating element-formed face of the ceramic substrate is made to a face for heating an object to be heated.

In the first aspect of the present invention, a thermocouple may be embedded in the ceramic substrate if necessary. This is because the thermocouple makes it possible to measure the temperature of the resistance heating elements and then the temperature can be controlled by changing the amount of voltage or electric current on the basis of the data.

Desirably, the size of the bonding part of the thermocouple is equal to or more than the strand diameter thereof, and is 0.5 mm or less. Such a structure causes the heat capacity of the connecting part to be small, and the temperature is correctly and promptly converted to an electric current value. Therefore, the controllability of the temperature is improved so that a temperature distribution in the heated face of the wafer becomes small.

Examples of the thermocouple include K-, R-, B-, S-, E-, J- and T-type thermocouples, as listed in JIS-C-1602 (1980).

The following will describe a method for producing the first ceramic heater.

First, a method for producing a ceramic heater wherein resistance heating elements are formed on the bottom face of the ceramic substrate 11 (reference to FIGS. 5 and 6) will be described.

A. Ceramic Heater Wherein Resistance Heating Elements are Formed on Bottom Face of Ceramic Substrate

(1) Step of Forming Ceramic Substrate

Powder made of a nitride ceramic or some other ceramic, for example, the above-mentioned aluminum nitride or silicon carbide, are blended with a sintering aid such as yttria (Y₂O₃) or B₄C, a compound containing Na or Ca, a binder and so on, based on the necessity, so as to prepare a slurry. Thereafter, this slurry is made into a granular form by spray-drying and the like. The granules are put into a mold and pressed to be formed into a plate form or some other form. Thus, a raw formed body(green) is produced.

Next, the following are formed in the raw formed body if necessary: portions which will be through holes for passing lifter pins for supporting a semiconductor wafer through; and portions which will be bottomed holes for embedding temperature measuring elements such as thermocouples. The through holes and the bottomed holes can be formed after the raw formed body is fired.

Next, this raw formed body is heated and fired to be sintered. Thus, a plate formed body of the ceramic is produced. Thereafter, the plate is made into a predetermined shape to produce the ceramic substrate 11. The shape of the raw formed body may be such a shape that the sintered body can be used as it is after the firing. By heating and firing the raw formed body under pressure, the ceramic substrate 11 having no pores can be produced. It is sufficient that the heating and the firing are performed at the sintering temperature or higher. The firing temperature is from 1000 to 2500° C. for nitride ceramics or carbide ceramics. The firing temperature is from 1500 to 2000° C. for oxide ceramics.

Usually, after the firing, through holes and bottomed holes for inserting temperature measuring elements are provided. The through holes and so on can be formed by grinding the surface and then performing drilling work, such as sandblast using SiC particles and the like.

(2) Step of Printing Conductor Containing Paste on Ceramic Substrate

A conductor containing paste is generally a fluid comprising metal particles, a resin and a solvent, and having a high viscosity. This conductor containing paste is printed on portions where resistance heating elements are to be formed by screen printing and the like. In this way, a conductor containing paste layer is formed. The resistance heating elements are printed into a pattern of a combination of concentric circles and winding lines as illustrated in FIG. 5 since it is necessary to make the whole of the ceramic substrate into an even temperature.

The conductor containing paste layer is desirably formed in such a manner that sections of the resistance heating elements 12 subjected to the firing are rectangular and flat.

Furthermore, in the case where the pattern is made to a pattern of concentric circles or a spiral, the portion perpendicular to the printing direction is ground with a belt sander to make the thickness even.

(3) Firing of Conductor Containing Paste

The conductor containing paste layer printed on the bottom face of the ceramic substrate 11 is heated or fired to remove the resin and the solvent and sinter the metal particles. Thus, the metal particles are baked onto the bottom face of the ceramic substrate 11 to form the resistance heating elements 12. The heating and firing temperature is preferably from 500 to 1000° C.

If the above-mentioned oxides are added to the conductor containing paste, the metal particles, the ceramic substrate and the oxides are sintered to be integrated with each other. Thus, the adhesiveness between the resistance heating elements and the ceramic substrate is improved.

(4) Step of Forming Metal Covering Layer

Next, a metal covering layer 1200 is desirably provided on the surface of the resistance heating elements 12. The metal covering layer 1200 can be formed by electroplating, electroless plating, sputtering and the like. From the viewpoint of mass-productivity, electroless plating is optimal. The surface may be covered with a covering body made of glass, resin and the like instead of the metal.

(5) Fiiting of Terminals and the Like

Terminals (external terminals 33) for connection to a power source are fitted up to ends of patterns of the resistance heating elements 12 with solder. Thermocouples are fixed to the bottomed holes 34 with brazing silver material, brazing gold material and the like. The bottomed holes are sealed with a heat-resistant resin such as polyimide, so as to complete the production of a ceramic heater.

The following will describe a method for producing a ceramic heater wherein the resistance heating elements 12 are formed inside the ceramic substrate 11.

B. Ceramic Heater Wherein Resistance Heating Elements are Formed Inside Ceramic Substrate

(1) Step of Forming Ceramic Substrate

First, ceramic powder of a nitride and the like is mixed with a binder, a solvent and the like to prepare a paste. This is used to form green sheets.

As the above-mentioned ceramic powder of the nitride and the like, aluminum nitride and the like can be used. If necessary, a sintering aid such as yttria, a compound containing Na or Ca, and the like may be added thereto.

As the binder, desirable is at least one selected from an acrylic resin binder, ethylcellulose, butylcellosolve, and polyvinyl alcohol.

As the solvent, desirable is at least one selected from α-terpineol and glycol.

A paste obtained by mixing these is formed into a sheet form by a doctor blade process, to produce green sheets.

The thickness of the green sheets is preferably from 0.1 to 5 mm.

Next, the following are formed in the resultant green sheet if necessary: portions which will be through holes for letting lifter pins for supporting a semiconductor wafer pass through; portions which will be bottomed holes for embedding temperature measuring elements such as thermocouples; portions which will be conductor filled through holes for connecting to resistance heating elements to external terminal pins. The above-mentioned working may be performed after a green sheet lamination which will be described later is formed.

(2) Step of Printing Conductor Containing Paste on Green Sheet

A metal paste or a conductor containing paste containing a conductive ceramic, for forming the resistance heating elements, is printed on the green sheet. The printed pattern at this time is preferably a pattern of a combination of concentric circles with winding lines, as illustrated in FIG. 5.

The conductor containing paste contains metal particles or conductive ceramic particles.

The average particle diameter of tungsten particles or molybdenum particles is preferably from 0.1 to 5 μm. If the average particle is less than 0.1 μm or exceeds 5 μm, the conductor containing paste is not easily printed.

Such a conductor containing paste may be a composition (paste) obtained by mixing, for example, 85 to 87 parts by weight of the metal particles or the conductive ceramic particles; 1.5 to 10 to parts by weight of at least one binder selected from acrylic resin binders, ethylcellulose, butylcellosolve and polyvinyl alcohol; and 1.5 to 10 parts by weight of at least one solvent selected from α-terpineol and glycol.

(3) Step of Laminating Green Sheets

Green sheets on which no conductor containing paste is printed are laminated on the upper and lower sides of the green sheet on which the conductor containing paste is printed.

At this time, the number of the green sheets laminated on the upper side is made larger than that of the green sheets laminated on the lower side so that the position where the resistance heating elements are formed is prejudiced toward the bottom face.

Specifically, the number of the green sheets laminated on the upper side is preferably from 20 to 50, and that of the green sheets laminated on the lower side is preferably from 5 to 20.

(4) Step of Firing Green Sheet Lamination

The green sheet lamination is heated and pressed to sinter the green sheets and the inner conductor containing paste layer.

The heating temperature is preferably from 1000 to 2000° C., and the pressing pressure is preferably from 100 to 200 kg/cm². The heating is performed in the atmosphere of an inert gas. As the inert gas, argon, nitrogen and the like can be used.

Bottomed holes, for inserting temperature measuring elements, may be provided after the firing is performed. The bottomed holes can be formed by grinding the surface and then subjecting the surface to blast treatment such as sandblast. External terminals are connected to the conductor filled through holes for connecting to the inner resistance heating elements, and heated for re-flowing. The heating temperature is preferably from 200 to 500° C.

Furthermore, thermocouples as temperature measuring elements are fitted thereto with brazing silver material, brazing gold material and the like, and then holes are sealed up with a heat-resistant resin such as polyimide, so as to complete the production of a ceramic heater.

The following will describe ceramic heaters according to second and third aspects of the present invention.

The ceramic heater according to the second aspect of the present invention comprises: a ceramic substrate; and a resistance heating element formed on the above-mentioned ceramic substrate, wherein a gutter or an incision is formed in the above-mentioned resistance heating element, and the above-mentioned gutter has a depth of 20% or more of the thickness of the resistance heating element.

The ceramic heater according to the third aspect of the present invention comprises: 0a ceramic substrate and a resistance heating element formed on the above-mentioned ceramic substrate, wherein a gutter or an incision is formed in the above-mentioned resistance heating element, and the resistance heating element-formed face of the above-mentioned ceramic substrate has a surface roughness of R≦20 μm.

The ceramic heater according to the second aspect of the present invention has a feature in that the gutter formed in the resistance heating element has a depth of 20% or more of the thickness of the resistance heating element, and the ceramic heater according to the third aspect of the present invention has a feature in that the resistance heating element-formed face of the ceramic substrate has the surface roughness of Ra≦20 μm. The two are the same except them. Accordingly, in the following description, the second aspect of the present invention and the third aspect of the present invention are explained at the same time. The characteristics of the respective present inventions are individually explained therein.

In the ceramic heaters according to the second and third aspects of the present invention, the face opposite to the resistance heating element-formed face is made to a heating face, and the gutter or incision is formed in the resistance heating element by trimming, so as to adjust the resistance value. As a result, the temperature distribution in the heating face becomes even.

The incision is a kind of cut formed to make the width of the resistance heating element locally narrow. By making the incision, the width of the resistance heating element is locally made narrow to adjust the resistance value. In the gutter, no cut portion is formed in the side face but in the incision a cut portion is formed in the side face. The two are different in this point.

In the ceramic heater having such a structure, the dispersion of the resistance value can be made small and a drop in oxidation resistance of the resistance heating element can be prevented. Furthermore, the strength of the ceramic substrate is not lowered.

In the ceramic heater according to the second aspect of the present invention, the gutter formed in the resistance heating element has a depth of 20% or more of the resistance heating element thickness; therefore, the change amount of the resistance value by trimming is large and the resistance value can easily be controlled. If the depth is less than 20% of the resistance heating element thickness, the resistance hardly changes. Thus, the resistance value is not easily controlled.

The gutter desirably has a depth of 50% or more of the resistance heating element thickness, and more desirably reaches the surface of the ceramic substrate. In the case where the gutter reaching the surface of the ceramic substrate is formed, the resistance heating element is completely separated by the formed gutter so that the length of the trim completely links with the change amount of the resistance value. Hence, the resistance value can be more easily controlled.

Furthermore, in the case where the gutter is also formed in the ceramic substrate, the depth thereof is desirably within 30% of the thickness of the ceramic substrate. If the depth exceeds 30%, the strength of the ceramic substrate drops so that the ceramic substrate warps easily.

In the ceramic heater according to the third aspect of the present invention, the gutter formed in the resistance heating element desirably has a depth of 20% or more of the resistance heating element thickness and more desirably has a depth of 50% or more thereof for the same reason as in the second aspect of the present invention. Still more desirably, the gutter reaches the surface of the ceramic substrate. In the case where the gutter is also formed in the ceramic substrate, the depth thereof is desirably within 30% of the thickness of the ceramic substrate.

In the second and third aspects of the present invention, the above-mentioned gutter is desirably formed along the direction in which electric current flows in the resistance heating element and in substantially parallel to the direction.

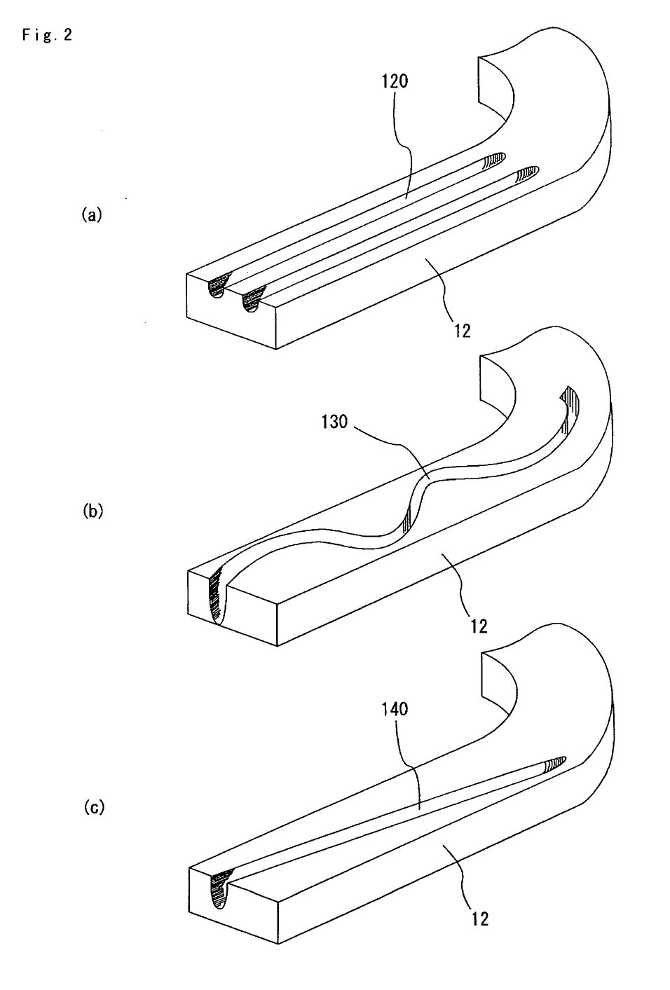

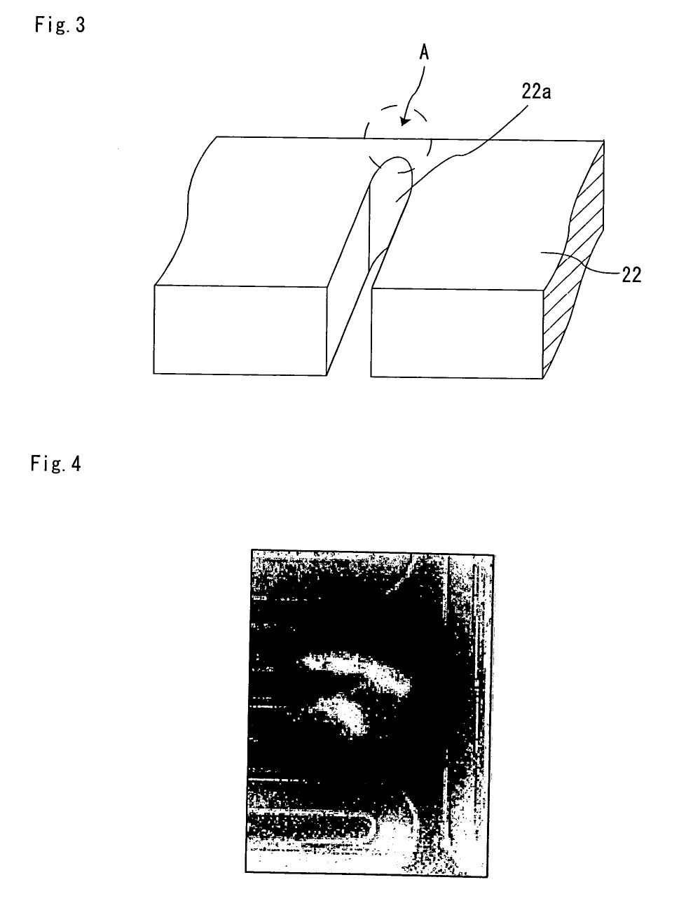

The trim is formed in the surface (upper face) of the resistance heating element. This is because if the trim is formed in a side face of the resistance heating element, a portion having a locally high resistance value is generated; thus, when heat is generated, the resistance heating element is melted. FIGS. 2(a) to 2(c) are perspective views, each of which schematically illustrates a resistance heating element 12 wherein its surface is trimmed in substantially parallel to a current-flowing direction. Gutters 120, 130 and 140 formed by trimming are in a straight line or curved line, as illustrated in FIGS. 2(a) to 2(c). A plurality of gutters in a straight line or curved line may be formed.

In the case where the resistance heating element is formed to be drawn as a arc, the resistance value thereof can be more largely changed by trimming the inner side of the arc resistance heating element. This is because electric current flows more easily in the inner side thereof.

In the second and third aspects of the present invention, about the dispersion of the resistance value of the resistance heating element, the dispersion of the resistance value to the average resistance value is desirably 5% or less, more desirably 1%. Even when the resistance heating element is divided into a plurality of circuits and they are controlled, the number of the divided circuits can be reduced by making the dispersion small as described above. Furthermore, the temperature in the heating face can be made even at temperature-rising transitional time.

If the dispersion of the resistance value of the resistance heating element exceeds 5%, the temperature evenness in the heating face is poor at stationary time and the temperature evenness in the heating face at transitional time, such as temperature-rising time, is also poor.

The dispersion of the resistance value of the resistance heating element is suppressed into 25% or less by making the thickness, the width and the like thereof uniform when the resistance heating element is printed, and is desirably suppressed into 5% or less by trimming. This is because if the dispersion is made smaller at the stage of printing the resistance heating element, adjustment based on trimming is made easier.

The width of the gutter is desirably about 1 to 1000 μm, more desirably about 1 to 100 μm. If the width exceeds 1000 μm, disconnection and the like is easily caused. On the other hand, if the width is less than 1 μm, it is difficult to adjust the resistance value of the resistance heating element. The spot diameter of the laser ray is desirably adjusted to 1 μm to 2 cm. The width is more desirably adjusted in the range of 50 μm to 2 cm.

The trimming is desirably performed on the basis of a value obtained by measuring the resistance value of the resistance heating element. This is because the resistance value can be precisely adjusted.

In the measurement of the resistance value, for example, the pattern of the resistance heating element is divided to sections l₁ to l₆ and then the resistance values of the respective sections are measured, as illustrated in FIG. 1. The section having a low resistance value is subjected to trimming treatment.

After the end of the trimming treatment, the resistance value is again measured and, if necessary, trimming may be further performed. That is, such resistance-value-measurement and trimming may be performed one time or may be performed two times or more.

The trimming is desirably performed after a paste of the resistance heating element is printed and then fired. This is because the resistance value varies by the firing or if the trimming is performed before the firing, the paste may exfoliate on account of irradiation with the laser ray.

First, the resistance heating element paste may be printed on the entire surface (in the so-called spread state), and then patterned by trimming. If the paste is printed into a pattern at an initial stage, a dispersion of the thickness thereof is generated in the printing direction. However, when the paste is printed in the spread state, the paste can be printed to have an even thickness. As a result, by trimming this into a pattern, a heating element pattern having an even thickness can be obtained.

The trimming can be performed using radiation of laser ray, sandblast, grinding treatment with a belt sander, and the like.

Examples of the laser ray include YAG laser, excimer laser (KrF), and carbon oxide laser.

The following will describe a trimming system of the second and third aspects of the present invention.

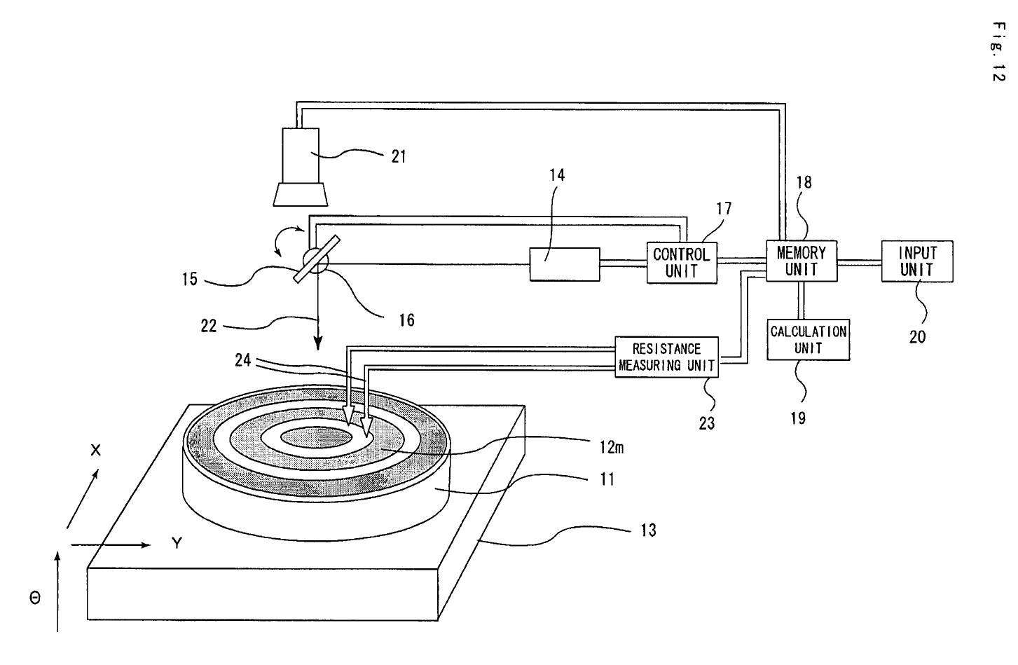

FIG. 12 is a block diagram illustrating an outline of a laser trimming device used to produce ceramic heaters according to the second and third aspects of the present invention.

As illustrated in FIG. 12, when laser trimming is performed, the following is fixed onto a table 13: a disc-shaped ceramic substrate 11 on which a conductor layer 12m is formed into a concentric circular shape having a predetermined width in such a manner that the layer 12m includes circuits of resistance heating element to be formed, or on which resistance heating elements having a predetermined pattern are formed.

This table 13 is provided with a motor and the like (not illustrated) and further the motor and the like are connected to a control unit 17. By driving the motor and the like through signals from the control unit 17, the table 13 can freely be moved into x, y directions (and additionally a θ direction).

A galvano mirror 15 is set up above this table 13. This galvano mirror 15 can freely be rotated by the motor 16. A laser ray 22 emitted from a laser radiation device 14 arranged above the table 13 similarly is applied to this galvano mirror 15 and reflected thereon. The reflected ray is applied to a ceramic substrate 11.

The motor 16 and the laser radiation device 14 are connected to the control unit 17. By driving the motor 16 and the laser radiation device 14 through signals from the control unit 17, the galvano mirror 15 is rotated by a predetermined angle. Thus, the position irradiated with the laser ray can freely be set along the x-y directions on the ceramic substrate 11.

By moving the table 13 on which the ceramic substrate 11 is placed and/or the galvano mirror 15 in this way, an arbitrary position on the ceramic substrate 11 can be irradiated with the laser ray 22.

A camera 21 is also installed on the table 13. In this way, the position (x, y) of the ceramic substrate 11 can be recognized. This camera 21 is connected to a memory unit 18, thereby recognizing the position (x, y) of the conductor layer 12m of the ceramic substrate 11. This position is irradiated with the laser ray 22.

An input unit 20 is connected to the memory unit 18, and has a keyboard and the like (not illustrated) as a terminal. Predetermined instructions are inputted through the memory unit 18, the keyboard 18 and the like to the input unit 20.

Furthermore, this laser trimming device is provided with a calculation unit 19, which calculates the position irradiated with the laser ray 22, radiation speed, the intensity of the laser ray, and the like on the basis of data on the position and the thickness of the ceramic substrate 11 recognized by the camera 21, and other data. On the basis of results of this calculation, instructions are supplied from the control unit 17 to the motor 16, the laser radiation device 14, and the like, to apply the laser ray 22 to predetermined positions while rotating the galvano mirror 15 or moving the table 13. In this way, unnecessary portions of the conductor layer 12m are trimmed, or portions in substantial parallel to the direction of electric current flowing in the resistance heating element pattern are trimmed. In such a way, the resistance heating element having a predetermined pattern is formed, or a gutter or an incision is formed in the resistance heating element.

This laser trimming device has a resistance measuring section. The resistance measuring section has tester pins, and the resistance heating element pattern is divided to a plurality of sections. The tester pins are brought into contact with the respective sections and the resistance values of the resistance heating elements are measured. Laser ray is applied to the sections to perform trimming in mostly parallel to the direction of electric current flowing in the resistance heating elements.

The following will specifically describe a method for producing a ceramic heater, using such a laser trimming device. Herein, a laser trimming step, which is an important step for the second and third aspects of the present invention, will be detailed, and steps other than the trimming step will briefly be described. These steps other than the trimming step will be described in more detail later.

First, a ceramic substrate is produced. A raw formed body made of ceramic powder and resin is first produced. The method of producing this raw formed body includes: a method of producing grains containing ceramic powder and resin, putting the grains into a mold and the like, and applying pressing pressure thereto; or a method of producing the raw formed body by laminating and compressing green sheets. A more appropriate method is selected dependently on whether or not other conductor layers, such as electrostatic electrodes, are formed. Thereafter, the raw formed body is degreased and fired to produce a ceramic substrate.

Thereafter, through holes for letting lifter pins pass through, and bottomed holes for embedding temperature measuring elements, are formed in the ceramic substrate.

Next, a conductor paste layer having a shape as illustrated in FIG. 12 is formed on this ceramic substrate 11 and in a wide region including portions which will be resistance heating elements. The workpiece is fired to form a conductor layer 12m.

The conductor layer may be formed by a plating method or a physical vapor deposition method such as sputtering. In the case of plating, a plating resist is formed. In the case of sputtering, selective etching is performed. In this way, the conductor layer 12m can be formed in the predetermined region.

The conductor layer may be formed as a resistance heating element pattern, as described above.

The ceramic substrate 11 on which the conductor layer 12m is formed in the predetermined region or the resistance heating elements having a predetermined pattern are formed in this way is fixed onto a predetermined position in the table 13.

Trimming data, data on the resistance heating element pattern, both of them, and the like are beforehand inputted to the input unit 20, and stored in the memory unit 19. That is, data on the shape to be formed by trimming are memorized. The trimming data are data used when trimming of the side face or the surface of the resistance heating element pattern, trimming in the thickness direction, trimming of a pattern in a ladder form, or some other trimming is performed. The data on the resistance heating element pattern are used when the conductor layer printed on the entire surface (in the so-called spread state) is trimmed to form the resistance heating element pattern. Of course, these can be used together.

In addition to these data, desired resistance value data may be inputted and stored in the memory unit. This process comprises the steps of measuring the resistance value actually in the resistance measuring section, calculating a difference thereof from a desired resistance value, calculating how to perform trimming in order to amend this actual value to the desired resistance value, and generating control data.

Next, the fixed ceramic substrate 11 is photographed with the camera 21 to memorize the position where the conductor layer 12m should be formed and the pattern of the resistance heating elements in the memory unit 18.

On the basis of the data on the position of the conductor layer, data on the shape to be formed by trimming, and the optional data on the resistance value, calculations are carried out in the calculation unit 19. The results are memorized as control data in the memory unit 18.

On the basis of the calculation results, control signals are generated from the control unit 17 to apply laser ray while driving the motor 16 for the galvano mirror 15, and/or the motor for the table 13. In this way, unnecessary portions in the conductor layer 12m or resistance heating element portions where their resistance is required to be raised are trimmed by the above-mentioned method.

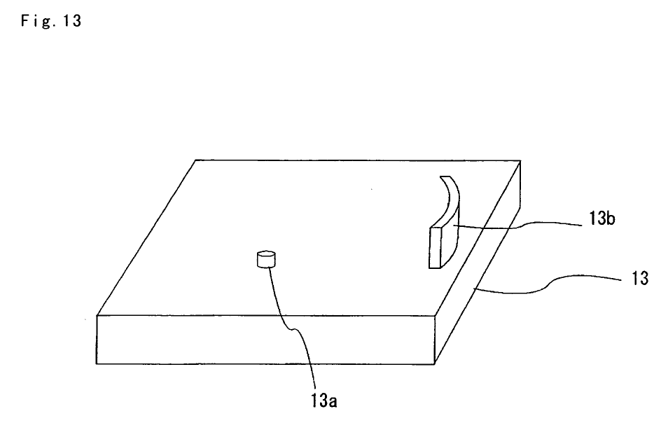

As illustrated in FIGS. 12 and 13, the table 13 has a fixing projection 13b which contacts the side face of the ceramic substrate 11, and a fitting projection 13a which is fitted into the through hole for letting a lifter pin pass through. These projections are used to fix the ceramic substrate 11 onto the table 13.

Thereafter, through the steps of connecting external terminals and setting temperature measuring elements, and other steps, the production of a ceramic heater completes.

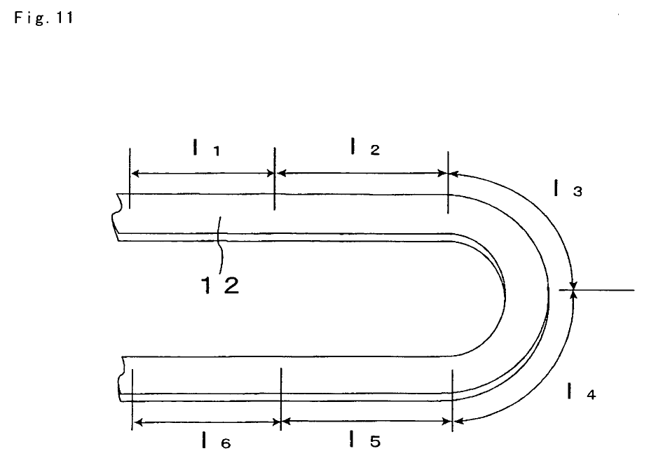

About the resistance value control, the resistance heating element pattern is divided to 2 or more sections (l₁ to l₆) and the resistance values of the respective sections are controlled, as illustrated in FIG. 11.

In the second and third aspects of the present invention, the resistance value is controlled by forming a gutter and the like in a part of the resistance heating element, as described above.

When a part of the conductor layer and the like is removed, portions to be trimmed in the conductor layer and the like are trimmed by application of laser ray thereto. It is however important that the application of the laser ray does not produce a large effect on the ceramic substrate present below the portions to be trimmed.

It is therefore necessary to select, as the laser ray, laser ray which is suitably absorbed in metal particles and the like which constitute the conductor layer and the like but is not easily absorbed in the ceramic substrate. The kind of such laser ray may be, for example, YAG laser, carbon dioxide laser, excimer laser or UV (ultraviolet) laser, as described above.

The required intensity of the laser ray varies dependently on the kind, the thickness and the like of the conductor layer to be removed, and is not generally specified. However, YAG laser or excimer (KrF) laser is optimal.

The YAG laser which can be adopted is, for example, SL432H, SL436G, SL432GT, SL411B and the like, manufactured by NEC Corp.

The laser is desirably a pulse ray. This is because the pulse ray makes it possible to apply a large energy to the resistance heating element in a very short time and make damage against the ceramic substrate small. The pulse is desirably 1 kHz or less in frequency. This is because if the pulse exceeds 1 kHz in frequency, the energy of a first pulse of the laser is high so that excessive trimming is performed.

The working speed is desirably 100 mm/second or less. If the working speed exceeds 100 mm/second, no gutter can be formed so far as the frequency is not made high. As described above, the frequency is desirably 100 mm/second or less since the upper limit of the frequency is 1 kHz or less.

Furthermore, in the case where a gutter reaching the ceramic substrate is formed in the resistance heating element, the output of the laser is desirably 0.3 W or more.

The ceramic substrate is preferably made of a material which does not absorb laser ray easily. For example, in the case of an aluminum nitride substrate, a substrate having small carbon content of 5000 ppm or less is preferred.

In the third aspect of the present invention, the surface roughness of the surface of the ceramic substrate is set to:Ra=20 μm or less according to JIS B 0601. The surface roughness of the surface of the ceramic substrate is desirably set to 10 μm or less. This is because when the surface roughness is large, the ceramic substrate absorbs laser ray.

The surface roughness is adjusted by grinding or polishing. The grinding is performed by use of a diamond grindstone of #200 to 1000 and applying a load of 1 to 100 kg/cm² to the substrate from both surfaces thereof. The polishing is performed by use of diamond paste containing diamond particles having a particle diameter of 0.1 to 100 μm and polishing cloth. The surface roughness is measured by use of a roughness surface meter manufactured by Keyence Co.

In the second aspect of the present invention, the surface roughness of the substrate surface is desirably set to 20 μm or less, more desirably 10 μm or less according to JIS B 0601 Ra for the same reason as in the third aspect of the present invention. The method of adjusting the surface roughness may be the same method as in the third aspect of the present invention.

The ceramic substrates according to the second and third aspects of the present invention have substantially the same structure as the ceramic heater according to the first aspect of the present invention except that a gutter or an incision is formed in their resistance heating element. The structure has already been described, using FIGS. 5 and 6. Thus, the description thereon will not be repeated.

In the case where a resistance heating element is provided on the surface (bottom face) of the ceramic substrate as in the second and third aspects of the present invention, the heating face is desirably at the side opposite to the resistance heating element-formed face. This is because the temperature evenness in the heating face can be improved since the ceramic substrate fulfils a role of heat diffusion.

The shape (diameter and thickness), the material and the like of the ceramic substrate in the ceramic heaters according to the second and third aspects of the present invention are the same as in the above-mentioned first aspect of the present invention. However, in order that the material of the ceramic heater will not absorb laser ray, it is necessary to adopt such a contrivance as making the amount of carbon small.

In the ceramic substrate which constitutes the ceramic heater according to the third aspect of the present invention, the surface is ground to adjust the roughness thereof to 20 μm or less according to JIS B0601 Ra, as described above. The roughness is desirably adjusted to 10 μm or less.

In the ceramic substrate which constitutes the ceramic heater according to the second aspect of the present invention, the surface is ground to adjust the roughness thereof to 20 μm or less according to JIS B0601 Ra. The roughness is desirably adjusted to 10 μm or less.

If necessary, in the second and third aspects of the present invention, a heat-resistant ceramic layer may be arranged between the resistance heating element and the ceramic substrate. For example, in the case of a non-oxide ceramic, an oxide ceramic may be formed on the surface.

In such a case, the surface roughness of the surface of the heat-resistant ceramic layer or the oxide ceramic layer is adjusted to 20 μm or less in the third aspect of the present invention. In such a case, the surface roughness of the surface of the heat-resistant ceramic layer or the oxide ceramic layer is desirably adjusted to 20 μm or less in the second aspect of the present invention.

In the second and third aspects of the present invention, the resistance heating element formed on the surface of the ceramic substrate or inside the ceramic substrate is desirably divided into two or more circuits. By the division into the circuits, electric powers supplied to the respective circuits (channels) can be controlled to change the amount of generated heat so that the temperature of the heated surface of a silicon wafer can be adjusted. The number of the circuit(s) is desirably less than 15. This is because the control thereof is easy. In the second aspect of the present invention, the number of the circuit(s) can be made as small as less than 15 since the dispersion of the resistance value can be made small.

Examples of the pattern of the resistance heating elements include concentric circuits, a spiral, eccentric circuits and winding lines. A concentric circular form pattern as illustrated in FIG. 5, or a combination of a concentric circular shape and a winding shape is preferred since the pattern makes it possible to make the temperature of the whole of the ceramic substrate even.

When the above-mentioned laser is used to form the resistance heating element, the case where the resistance heating element has a complicated pattern wherein an interval between wirings is narrow is favorable.

As the method of forming the resistance heating element on the surface of the ceramic substrate, the above-mentioned method is used. That is, a conductor containing paste is applied to predetermined regions in the ceramic substrate, next a conductor containing paste layer is formed, and subsequently trimming treatment with a laser is performed; or a conductor containing paste is baked and subsequently trimming treatment with a laser is performed to form a resistance heating element having a predetermined pattern. By firing, metal particles can be sintered on the surface of the ceramic substrate through glass frit and the like. The metal sintering is sufficient if the metal particles are melted and adhered to each other and the metal particles and the ceramic are melted and adhered to each other. Trimming is optimally performed after the firing. This is because the resistance value can be more precisely controlled after the firing since the resistance value is varied by the firing.

A method such as plating or sputtering may be used to form a conductor layer in predetermined regions, and then the layer is subjected to trimming treatment with a laser.

In the ceramic heaters according to the second and third aspects of the present invention, the resistance heating element is formed on the surface of the ceramic substrate, and the thickness of the resistance heating element is preferably from 1 to 30 μm, more preferably from 1 to 15 μm. The width of the resistance heating element is preferably from 0.5 to 20 mm, more preferably from 0.5 to 5 mm.

The resistance value of the resistance heating element can be changed dependently on its width or thickness. The above-mentioned ranges are however most practical. This resistance value (volume resistivity) can be adjusted by use of laser ray, as described above.

In the ceramic heaters according to the second and third aspects of the present invention, the sectional shape and the aspect ratio of the resistance heating element formed in the ceramic substrate are the same as in the first aspect of the present invention, and have already been described. Thus, description thereon will not be repeated.

The conductor containing paste used to form the resistance heating element is also the same as in the first aspect of the present invention, and has already been described. Thus, description thereon will not be repeated.

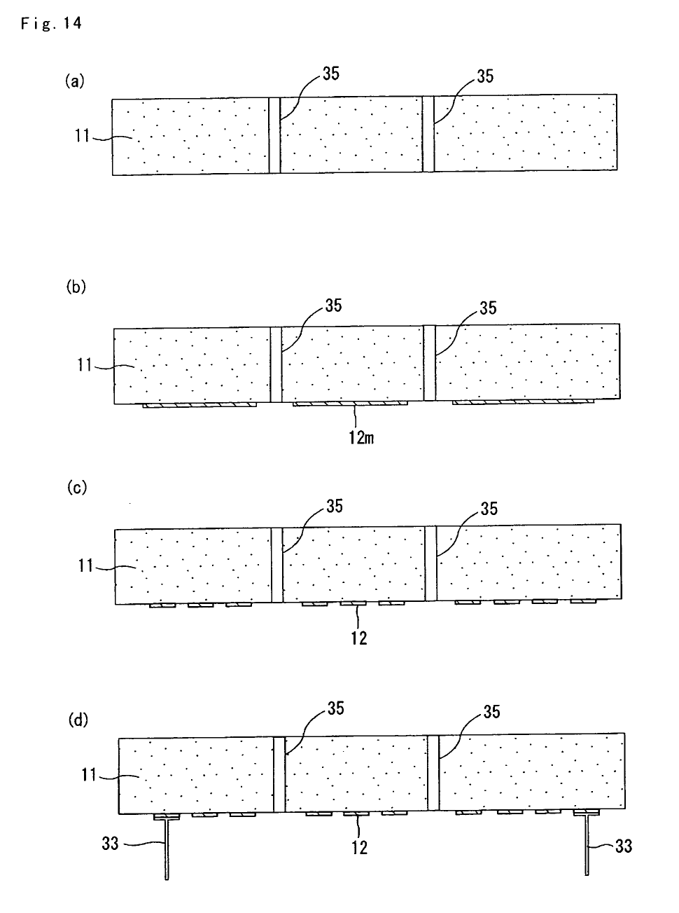

About a method for producing the ceramic heater of the present invention, comprising laser treatment, the following will describe steps except the laser treatment step in detail on the basis of FIG. 14. The laser treatment step has been previously described in detail. Thus, the step is briefly described herein.

FIGS. 14(a) to 14(d) are sectional views which schematically illustrate parts of a method for producing the ceramic heater of the present invention, the method comprising laser treatment.

(1) Step of Forming Ceramic Substrate

A ceramic substrate 11 having through holes 35 and bottomed holes (not illustrated) are produced in the same way in the (1) of A. in the above-mentioned method for producing the ceramic heater according to the first aspect of the present invention (reference to FIG. 14(a)).

(2) Step of Printing Conductor Containing Paste on Ceramic Substrate

A conductor containing paste is generally a fluid comprising metal particles, a resin and a solvent, and having a high viscosity. This conductor containing paste is printed on the whole of regions where resistance heating elements are to be formed by screen printing and the like. In this way, a conductor containing paste layer 12m is formed (reference to FIG. 14(b)).

Since it is necessary to make the whole of the ceramic substrate into an even temperature, the pattern of the resistance heating elements is desirably made to a pattern made of a concentric circular shape and a bending shape, as illustrated in FIG. 5. In order that the conductor containing paste layer can contain these patterns, the layer is made into a concentric circular shape or circular shape pattern having a large width.

(3) Firing of Conductor Containing Paste

The conductor containing paste layer printed on the bottom face of the ceramic substrate 11 is heated or fired to remove the resin and the solvent and sinter the metal particles. Thus, the metal particles are baked onto the bottom face of the ceramic substrate 11 to form a conductor layer having a predetermined width (reference to FIG. 5). Thereafter, trimming treatment using the above-mentioned layer is performed to form resistance heating elements 12 having a predetermined pattern (reference to FIG. 14(c)). The heating and firing temperature is preferably from 500 to 1000° C.

It is allowable that a pattern such as a concentric circle, spiral, or bending pattern is firstly formed and parts thereof are subjected to trimming treatment to adjust the resistance value thereof, thereby forming resistance heating elements 12.

(4) Formation of Metal Covering Layer

As illustrated in FIG. 6, a metal covering layer 1200 is desirably provided on the surface of the resistance heating elements 12. The metal covering layer 1200 can be formed by electroplating, electroless plating, sputtering and the like. From the viewpoint of mass-productivity, electroless plating is optimal. In FIG. 14, the metal covering layer 1200 is not illustrated. The surface may be covered with a covering body made of glass, resin and the like instead of the metal.

(5) Fitting of Terminals and the Like

Terminals (external terminals 33) for connection to a power source are fitted up to ends of patterns of the resistance heating elements 12 with solder (reference to FIG. 14(d)). Thermocouples are inserted into the bottomed holes 34. The bottomed holes are sealed with a heat-resistant resin such as polyimide, so as to complete the production of a ceramic heater.

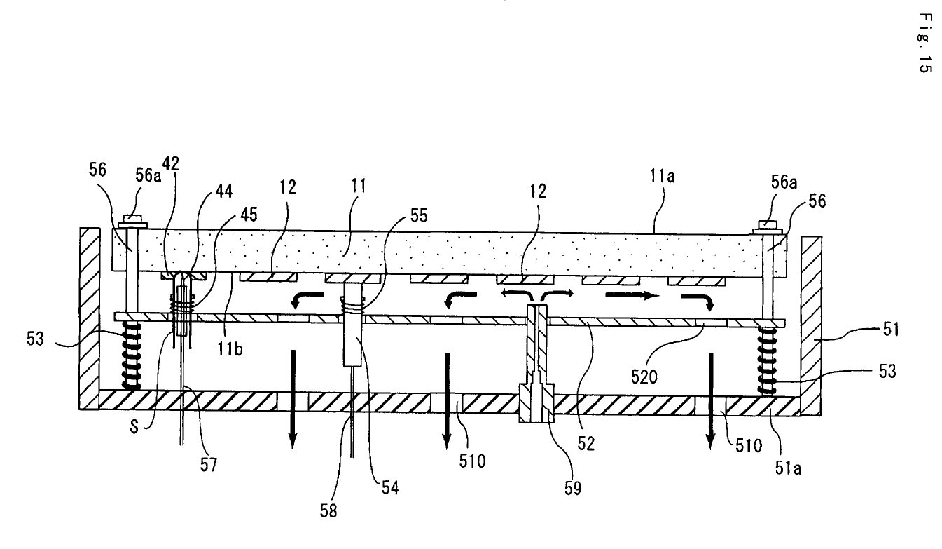

FIG. 15 is a sectional view which schematically illustrates a ceramic heater unit produced in such a way.

In this ceramic heater unit, supporting columns 56 are formed in a supporting case 51 to support a ceramic substrate 11. Resistance heating elements 12 are formed on the bottom face of the ceramic substrate 11. An intermediate plate 52 having an opening 520 for preventing overheating of the ceramic substrate 11 by radiant heat is fitted to the middle of the supporting columns 56, and is supported by springs 53. A bottom plate 51a having an opening 510 is formed at the bottom of the supporting case 51. A supply port 59 for supplying a cooling medium is provided therein.

Electric power is supplied through a power supplying terminal 54. A thermocouple 44 is pressed, through an electric heat plate 42, on the ceramic substrate 11 by power of the springs 45.

When this ceramic heater unit is cooled, the cooling medium is introduced into the supporting case 51. This cooling medium flows in from the supply port 59, and conducts heat exchange while contacting the resistance heating elements 12 and the ceramic substrate 11. The cooling medium is then discharged from the opening 510.

The cooling medium may be any one of liquid and gas if the medium is a fluid. Examples of the liquid include water, ammonia, alcohol, and ethylene glycol, and examples of the gas include nitrogen, carbon dioxide, argon, neon, and air.

The ceramic heaters according to the first, second and third aspects of the present invention can be used as an electrostatic chuck by providing electrostatic electrodes inside their ceramic substrate. The ceramic heaters can be used as a chuck top plate of a wafer prober by providing a chuck top conductor layer on the surface and providing guard electrodes and ground electrodes inside.

### BEST MODES FOR CARRYING OUT THE INVENTION

The present invention will be described according to Examples in more detail hereinafter.

### EXAMPLE 1

(1) A composition made of 100 parts by weight of aluminum nitride powder (average particle diameter: 0.6 μm), 4 parts by weight of yttria (average particle diameter: 0.4 μm), 12 parts by weight of an acrylic binder, and an alcohol was subjected to spray-drying to yield granular powder.

(2) Next, this granular powder was put into a mold and formed into a flat plate form, so as to obtain a raw formed body(green).

(3) Next, this raw formed body was hot-pressed at 1800° C. and a pressure of 20 MPa, to yield an aluminum nitride plate having a thickness of about 3 mm.

Next, this plate was cut off into a disc having a diameter of 210 mm to prepare a plate formed body of the ceramic (ceramic substrate 11). This ceramic substrate was drilled to make through holes 35 for letting lifter pins 36 for a silicon wafer pass through, and bottomed holes 34 (diameter: 1.1 mm, and depth: 2 mm) for embedding thermocouples. The porosity of the ceramic substrate was about 0%.

The porosity was measured as follows: the ceramic was pulverized, and immersed into mercury or an organic solvent to measure the volume thereof. The true gravity was calculated from the weight which was beforehand measured. From the obtained true gravity and the apparent gravity calculated from the shape, the porosity was calculated.

(4) A conductor containing paste layer was formed on the ceramic substrate 11 obtained in the above-mentioned (3) by screen printing. The printed pattern was a pattern as illustrated in FIG. 5.

The used conductor containing paste was a paste having a composition of Ag: 48% by weight, Pt: 21% by weight, SiO₂: 1.0% by weight, B₂O₃: 1.2% by weight, ZnO: 4.1% by weight, PbO: 3.4% by weight, ethyl acetate: 3.4% by weight, and butyl carbitol: 17.9% by weight.

This conductor containing paste was a Ag—Pt paste. Silver particles thereof had an average particle diameter of 4.5 μm, and were scaly. Pt particles had an average particle diameter of 0.5 μm, and were spherical.

(5) Furthermore, the ceramic substrate 11 was heated and fired at 780° C. after the formation of the conductor containing paste layer for a heating element pattern, so as to sinter Ag and Pt in the conductor containing paste and bake Ag and Pt onto the substrate 11.

The pattern of the resistance heating elements 12 had seven channels 12a to 12g, as illustrated in FIG. 5. Three channels (12e to 12g) thereof were present in the inner portion, and four channels (12a to 12d) thereof were present in the peripheral portion.

A channel represents a circuit to which the identical voltage is applied when control is performed, so as to perform single control. In the present example, however, the channel represents each of the resistance heating elements (12a to 12d) formed as a continuous body.

(6) The dispersion of the resistance in each of the channels (resistance heating elements 12a to 12d) was obtained by dividing the pattern in the same channel, measuring resistances at both ends of the respective divided regions, calculating the average thereof as an average resistance value, and calculating the dispersion in the single channel from a difference between the highest resistance value and the lowest resistance value, and the average resistance value. The dispersion of the resistance value is calculated for each of the channels. In the present invention, it is sufficient that the largest dispersion value of the resistance heating elements is 25% or less.

(7) Next, a silver-lead solder paste (manufactured by Tanaka Kikinzoku K.K) was printed on portions to which external terminals 33 for ensuring connection to a power source would be fitted by screen printing, so as to form a solder layer.

Next, the external terminals 33 made of kovar were placed on the solder layer, and the solder was heated and re-flowed at 420° C. to fit the external terminals 33 to the surface of the resistance heating elements 12.

(8) Thermocouples for controlling temperature were sealed with polyimide, to yield a ceramic heater 10.

### EXAMPLE 2

Example 2 was similar to Example 1, and a ceramic substrate was produced as follows.

(1) A composition made of 100 parts by weight of SiC powder (average particle diameter: 1.1 μm), 4 parts by weight of B₄C, 12 parts by weight of an acrylic binder, and an alcohol was subjected to spray-drying to yield granular powder.

(2) Next, this granular powder was put into a mold and formed into a flat plate form to obtain a raw formed body(green).

(3) Next, this raw formed body was hot-pressed at 1890° C. and a pressure of 20 MPa, to yield a SiC plate having a thickness of about 3 mm. Furthermore, the surface was ground with a diamond grindstone of #800, and polished with a diamond paste to set the Ra thereof to 0.008 μm. Furthermore, the surface was coated with a glass paste (G-5177, manufactured by Shoei Chemical Industries Co., Ltd.), and the temperature of the resultant was raised to 600° C. In this way, a SiO₂ layer having a thickness of 2 μm was formed. The porosity of the ceramic substrate was 3%.

Next, this plate was cut off into a disc having a diameter of 210 mm to prepare a plate formed body of the ceramic (ceramic substrate 11). This ceramic substrate was drilled to form through holes 35 for letting lifter pins 36 for a silicon wafer pass through, and bottomed holes 34 (diameter: 1.1 mm, and depth: 2 mm) for embedding thermocouples.

(4) Furthermore, the ceramic substrate 11 was heated and fired at 780° C. after the formation of the conductor containing paste layer for a heating element pattern, so as to sinter Ag and Pt in the conductor containing paste and bake Ag and Pt onto the substrate 11.

The pattern of the resistance heating elements 32 had nine channels, as illustrated in FIG. 9, and a spiral pattern.

Accordingly, the thickness of the portion perpendicular to the printing direction was larger than that of other portions. Thus, the portion perpendicular to the printing direction, out of the pattern of the resistance heating elements 32, was ground with a belt sander wherein a grinding paper of #200 was rotated to perform grinding.

(5) The dispersion of the resistance was obtained by dividing the pattern in the same channel, measuring resistances at both ends of the respective divided regions, calculating the average thereof as an average resistance value, and calculating the dispersion of the single channel from a difference between the highest resistance value and the lowest resistance value, and the average resistance value. The dispersion of the resistance value is calculated for each of the channels. It is sufficient that the largest dispersion value is 25% or less.

(6) Next, a silver-lead solder paste (manufactured by Tanaka Kikinzoku K.K) was printed on portions to which external terminals 13 for ensuring connection to a power source would be fitted by screen printing, so as to form a solder layer.

Next, the external terminals 13 made of kovar were placed on the solder layer, and the solder was heated and re-flowed at 420° C. to fit the external terminals 13 to the surface of the resistance heating elements 12.

(7) Thermocouples for controlling temperature were sealed with polyimide, to yield a ceramic heater 10.

### EXAMPLE 3

(1) The following paste was used to perform formation by a doctor blade method, so as to form a green sheet having a thickness of 0.47 μm: a paste obtained by mixing 100 parts by weight of aluminum nitride powder (manufactured by Tokuyama Corp., average particle diameter: 0.6 μm), 4 parts by weight of alumina, 11.5 parts by weight of an acrylic resin binder, 0.5 part by weight of a dispersant and 53 parts by weight of alcohols of 1-butanol and ethanol.

(2) Next, this green sheet was dried at 80° C. for 5 hours, and subsequently the following portions were formed by punching: portions which would be through holes 35 for letting lifter pins for carrying a semiconductor wafer pass through; portions which would be via holes; and portions which would be conductor filled through holes.

(3) The following were mixed to prepare a conductor containing paste A: 100 parts by weight of tungsten carbide particles having an average particle diameter of 1 μm, 3.0 parts by weight of an acrylic resin binder, 3.5 parts by weight of α-terpineol solvent, and 0.3 part by weight of a dispersant.

The following were mixed to prepare a conductor containing paste B: 100 parts by weight of tungsten particles having an average particle diameter of 3 μm, 1.9 parts by weight of an acrylic resin binder, 3.7 parts by weight of α-terpineol solvent, and 0.2 part by weight of a dispersant.

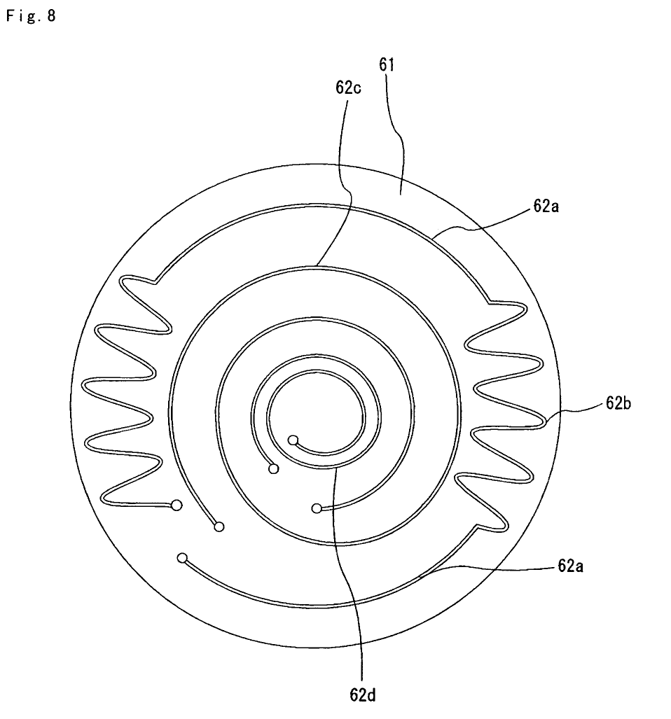

This conductor containing paste A was printed on the green sheet wherein the portions which would be the via holes were made by screen printing, so as to form a conductor containing paste layer for resistance heating elements. The printed pattern was made into a spiral pattern and a partially-bending pattern, as illustrated in FIG. 8.

The width of the conductor containing paste layer was set to 10 mm, and the thickness thereof was set to 12 μm. The dispersion of the thickness was ±0.5 μm as a whole. However, the dispersion was not localized.

Subsequently, by screen printing, the conductor containing paste A was printed on the green sheet wherein the portions which would be the conductor filled through holes were made, so as to form a conductor containing paste layer for conductor circuits. The printing shape was made into a belt shape.

Moreover, the conductor containing paste B was filled into the portions which would be the via holes and the portions which would be conductor filled through holes.

Thirty seven green sheets on which no conductor containing paste was printed were stacked on the upper side of the green sheet that had been subjected to the above-mentioned processing, wherein the conductor containing paste was printed, and then a sheet wherein the conductor containing paste was printed was stacked on the lower side thereof. Furthermore, twelve green sheets wherein no conductor containing paste was printed were stacked on the lower side thereof. The green sheets were laminated at 130° C. and a pressure of 8 MPa.

(4) Next, the resultant lamination was degreased at 600° C. in the atmosphere of nitrogen gas for 5 hours and hot-pressed at 1890° C. and a pressure of 15 MPa for 10 hours to yield a ceramic plate 5 mm in thickness. This was cut off into a disc 230 mm in diameter to prepare a ceramic plate having therein resistance heating elements having a thickness of 6 μm and a width of 10 mm and conductor filled through holes.

(5) Next, the ceramic plate obtained in the (4) was ground with a diamond grindstone. Subsequently, a mask was put thereon, and bottomed holes for thermocouples were made in the surface by blast treatment with SiC particles and the like.

(6) Thermocouples for temperature control were inserted into the bottomed holes, and silica gel was filled. The silica gel was hardened and gelation occured at 190° C. for 2 hours to yield a ceramic heater having the resistance heating elements and the conductor filled through holes.

### EXAMPLE 4

In the present example, a ceramic heater was produced in substantially the similar manner to Example 1, but the pattern of its resistance heating elements was made to a pattern of only winding lines, illustrated in FIG. 10.

### COMPARATIVE EXAMPLE 1

A ceramic heater was produced in the similar manner to Example 1 except that the pattern of its resistance heating elements to be formed was made to a concentric circular pattern illustrated in FIG. 9.

### COMPARATIVE EXAMPLE 2

A ceramic heater was produced in the similar manner to Example 1 except that the pattern of its resistance heating elements to be formed was made to a concentric circular pattern illustrated in FIG. 9 and the thickness of its substrate was set to 28 mm.

### COMPARATIVE EXAMPLE 3

A ceramic heater was produced in the similar manner to Example 1 except that the pattern of its resistance heating elements to be formed was made to a concentric circular pattern illustrated in FIG. 9 and the diameter of its substrate was set to 150 mm.

### COMPARATIVE EXAMPLE 4

A ceramic heater was produced in the similar manner to Example 2 except that no sintering aid was added. The porosity thereof was 5.5%. The pattern of its resistance heating elements was made to a concentric circular pattern illustrated in FIG. 9.

About the ceramic heaters obtained in Examples 1 to 4 and Comparative Example 1, the dispersion of the resistance value of the resistance heating elements was measured. The results are shown in the following Table 1.

TABLE 1

| | 1 | 2 | 3 | 4 | 5 | 6 | 7 | 8 | 9 |
|---|---|---|---|---|---|---|---|---|---|
| Example 1 | 10.4 | 11.0 | 10.5 | 11.6 | 7.0 | 7.4 | 12.4 | — | — |
| Example 2 | 11.4 | 10.5 | 11.3 | 11.7 | 12.4 | 11.5 | 10.7 | 11.4 | 12.5 |
| Example 3 | 19.4 | 15.0 | 15.5 | 15.6 | 10.0 | 10.5 | 15.1 | — | — |
| Example 4 | 11.5 | 10.8 | 11.8 | 11.8 | 6.5 | 6.0 | 7.4 | 8.0 | — |
| Comparative | 26.0 | 27.0 | 26.5 | 26.2 | 22.0 | 20.0 | 15.0 | 18.0 | 20.3 |
| Example 1 | | | | | | | | | |

Notes)
The numbers in the highest row represent the channel number of the resistance heating elements.
About the ceramic heaters according to Examples 1, 3 and 4, the channel numbers are assigned in the order of 12a to 12g, and about the ceramic heaters according to Example 2 and Comparative Example 1, the channel numbers are assigned in order from the outermost resistance heating element.

The ceramic heaters according to Examples 1 to 4 and Comparative Examples 1 to 4 obtained through the above-mentioned steps were evaluated on the basis of the following indexes. At this time, a temperature adjustor (E5ZE, manufactured by Omron Co.) was fitted to each of the resultant ceramic heaters, and performances thereof were evaluated. The results are shown in Table 2.

(1) Temperature Evenness in Heating Face

A silicon wafer to which 17-point temperature measuring elements were fitted was used to measure distribution in the in-face temperature. The temperature distribution is indicated by the difference between the highest temperature and the lowest temperature when setting temperature was made to 200° C.

(2) Evenness of In-Face Temperature at Transitional Time, and Temperature-Rising Time

Distribution in the in-face temperature was measured when the temperature of each of the heaters was raised from room temperature to 130° C. The temperature distribution is indicated by the difference between the highest temperature and the lowest temperature. The temperature-rising time was also measured when the temperature was raised.

(3) Recovery Period

In the case where setting temperature was 140° C. and a silicon wafer of 25° C. was placed on the ceramic heater, the period until the temperature was recovered to 140° C. (recovery time) was measured.

TABLE 2

| | | Distribution in | | |
|---|---|---|---|---|
| | Distribution | the in-face | temperature- | |
| | in the in-face | temperature at | rising | Recovery |
| | temperature | transitional time | time | time |
| | (° C.) | (° C.) | (second) | (second) |
| Example 1 | 0.5 | 6.5 | 180 | 35 |
| Example 2 | 0.5 | 6.3 | 180 | 35 |
| Example 3 | 0.6 | 6.5 | 180 | 35 |
| Example 4 | 0.4 | 6.0 | 180 | 33 |
| Comparative | 1.5 | 8.0 | 180 | 48 |
| Example 1 | | | | |
| Comparative | 0.5 | 10.0 | 600 | 300 |
| Example 2 | | | | |
| Comparative | 0.7 | 7.0 | 180 | 38 |
| Example 3 | | | | |
| Comparative | 0.7 | 10.0 | 300 | 120 |
| Example 4 | | | | |

As is evident from Table 1, the dispersion of the resistance value of the resistance heating elements was 20% or less in each of the channels in Examples 1 to 4, and the dispersion was 6% in the example exhibiting the highest precision.

On the other hand, Comparative Example 1 had a channel exhibiting a dispersion of 27%, and thus the dispersion of the resistance value was large.

As is also evident from the description in Tables 1 and 2, in the ceramic heaters according to resistance 1 to 4, no dispersion of the resistance value was caused in the same channel, and further no resistance dispersion was caused between the respective channels. Therefore, the in-face temperature evenness is superior at stationary time and transitional time. Since the resistance value is even, the temperature is easily controlled and the recovery time is also short.

On the other hand, in the ceramic heater according to Comparative Example 1, the resistance dispersion cannot be made small in the same channel; therefore, the in-face temperature evenness at stationary time and transitional time is poor. The temperature controllability is poor and the recovery time is also long.

Furthermore, in the ceramic heater according to Comparative Example 2, the substrate is thick so that the heat capacity is too large and hence the temperature cannot be controlled. Accordingly, the in-face temperature distribution at transitional time is too large so that the controllability is poor. At stationary time, the temperature distribution is smaller as the heat capacity is larger.

It is understood that in the ceramic heater according to Comparative Example 3, the diameter of the substrate is small so that the dispersion of the resistance value is not reflected as temperature distribution.

In the ceramic heater according to Comparative Example 4, the porosity is too high so that the heat conductivity drops and hence the temperature cannot be controlled. Accordingly, the in-face temperature distribution at transitional time is too large so that the controllability is poor. At stationary time, the heat conductivity is poor and the temperature distribution is small.

### EXAMPLE 5

(1) A composition made of 100 parts by weight of aluminum nitride powder (average particle diameter: 0.6 μm), 4 parts by weight of yttria (average particle diameter: 0.4 μm), 12 parts by weight of an acrylic binder, and an alcohol was subjected to spray-drying to yield granular powder.

(2) Next, this granular powder was put into a mold and formed into a flat plate form, to obtain a raw formed body(green).

(3) Next, this raw formed body was hot-pressed at 1800° C. and a pressure of 20 MPa, to yield an aluminum nitride plate having a thickness of about 3 mm.

Next, this plate was cut off into a disc having a diameter of 210 mm to prepare a plate formed body of the ceramic (ceramic substrate 11). This ceramic substrate was drilled to make through holes 35 for letting lifter pins 36 for a silicon wafer pass through, and bottomed holes 34 (diameter: 1.1 mm, and depth: 2 mm) for embedding thermocouples.

(4) A conductor containing paste layer was formed on the ceramic substrate 11 obtained in the above-mentioned (3) by screen printing. The printed pattern was a pattern as illustrated in FIG. 1.

The used conductor containing paste was a paste having a composition of Ag: 48% by weight, Pt: 21% by weight, SiO₂: 1.0% by weight, B₂O₃: 1.2% by weight, ZnO: 4.1% by weight, PbO: 3.4% by weight, ethyl acetate: 3.4% by weight, and butyl carbitol: 17.9% by weight.

This conductor containing paste was a Ag—Pt paste. Silver particles thereof had an average particle diameter of 4.5 μm, and were scaly. Pt particles had an average particle diameter of 0.5 μm, and were spherical.

(5) Furthermore, the ceramic substrate 11 was heated and fired at 850° C. after the formation of the conductor containing paste layer for a heating element pattern, so as to sinter Ag and Pt in the conductor containing paste and bake Ag and Pt onto the substrate 11.

The pattern of resistance heating elements had seven channels 12a to 12g, as illustrated in FIG. 5. Table 3 describes the dispersion of the resistance values in each of the four channels in the peripheral portion (the resistance heating elements 12a to 12d) before trimming. A channel represents a circuit to which the identical voltage is applied in order to perform single control. In the present example, however, the channel represents each of the resistance heating elements (12a to 12d) formed as a continuous body.

The resistance dispersion of each of the channels (resistance heating elements 12a to 12d) was obtained by dividing the channel into 20 pieces, measuring resistances at both ends of the respective divided regions, calculating the average thereof as an average division resistance value (average value in Table 1), and calculating the dispersion from the difference between the highest resistance value and the lowest resistance value inside the channel, and the average division resistance value. The resistance value of each of the channels (resistance heating elements 12a to 12d) is the summation of all resistance values measured about the divided regions.

(6) Next, as a trimming device, a YAG laser (S143AL manufactured by NEC Corp., power: 5 W, and pulse frequency: 0.1 to 40 kHz) having a wavelength of 1060 nm was used. This device has an X-Y stage, a galvano mirror, a CCD camera, and a Nd:YAG laser, and has therein a controller for controlling the stage and the galvano mirror. The controller was connected to a computer (FC-9821, manufactured by NEC Corp.). The computer has a CPU functioning as both of a calculating section and a memory unit. The computer also has a hard disc and a 3.5-inch FD driver functioning as a memory unit and an input unit.

Heating element pattern data were inputted from the FD driver to this computer, and further the position of the conductor layer was read out (on the basis of markers, as standards, formed at specified positions in the conductor layer and in the ceramic substrate). Necessary control data were calculated, and a laser was applied to the ceramic substrate in substantial parallel to the direction of current flowing in the heating element pattern, to remove the conductor layer in the laser-applied portions. In this way, gutters having a width of 50 μm were formed until the gutters reached 30%, 60% and 90% of the thickness of the resistance heating elements, and the ceramic substrate, respectively, and the same gutters were formed until the depth of the gutters in the ceramic substrate was 2 μm. The measurement was made with a laser displacement meter manufactured by Keyence Co.

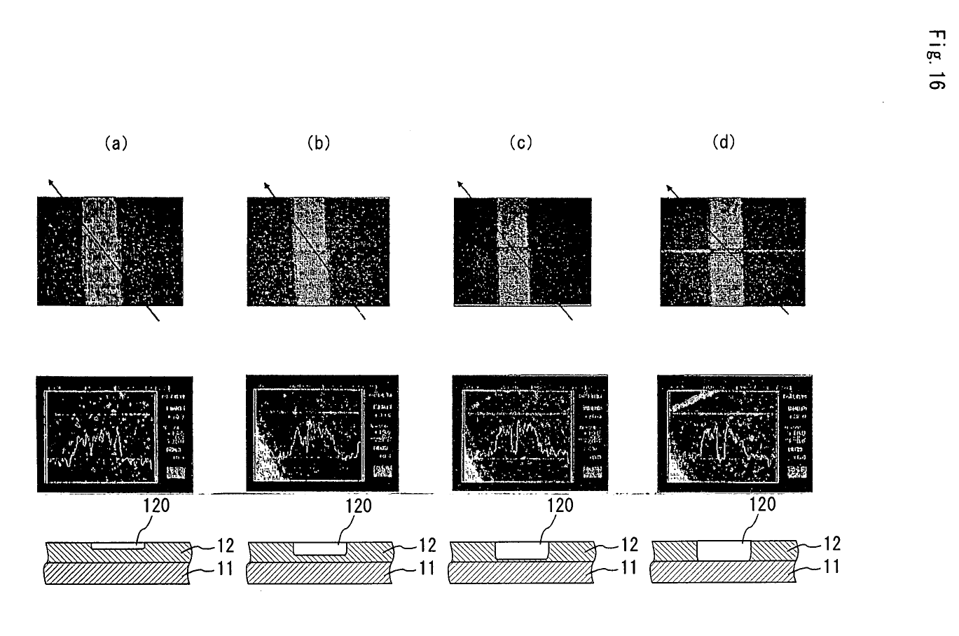

FIGS. 16(a) to 16(d) are concerned with gutters having a depth of 30%, 60% and 90% of the thickness of the resistance heating elements, respectively, and a gutter reaching the ceramic substrate, and the upper row thereof gives photographs showing external appearances thereof, the middle row thereof gives graphs showing the shape (height and position) of sections, and the lower row gives sectional views in the case where the external appearances in the upper row are cut along the direction of respective arrows.

However, in order to show the gutters clearly in the above-mentioned photos and graphs, the gutters were formed perpendicularly to the direction in which electric current would flow in the resistance heating elements. Actually, the gutters were different from the gutters formed in the above-mentioned examples.

The resistance heating elements had a thickness of 10 μm and a width of 2.4 mm. The laser had a frequency of 1 kHz, a power of 0.4 W, and a band size of 10 μm. The working speed was 10 mm/second. The resistance values of the four channels in the peripheral portion after the trimming, and the dispersion of each of the channels are shown in Table 3. The resistance dispersion of the channel was obtained by dividing the channel into 20 pieces, measuring resistances at both ends of the divided regions, calculating the average thereof as an average division resistance value, and further calculating the dispersion from difference between the highest resistance value and the lowest resistance value inside the channel, and the average division resistance value. The resistance value of each of the channels is the summation of all resistance values measured about the divided regions.

(7) Portions to which external terminals 13 for ensuring connection to a power source would be fitted were subjected to Ni plating, and subsequently a silver-lead solder paste (manufactured by Tanaka Kikinzoku K.K) was printed by screen printing, so as to form a solder layer.

Next, the external terminals 13 made of kovar were placed on the solder layer, and the solder was heated and re-flowed at 420° C. to fit the external terminals 13 to the surface of the resistance heating elements 12.

(8) Thermocouples for controlling temperature were sealed with polyimide, to yield a ceramic heater 10.

### EXAMPLE 6

A ceramic heater was produced and the dispersion of the resistance value of its resistance heating elements was measured in the similar manner to Example 1 except that its ceramic substrate was produced as follows.

(1) A composition made of 100 parts by weight of SiC powder (average particle diameter: 1.1 μm), 4 parts by weight of B₄C, 12 parts by weight of an acrylic binder, and an alcohol was subjected to spray-drying to yield granular powder.

(2) Next, this granular powder was put into a mold and formed into a flat plate form to obtain a raw formed body(green).

(3) Next, this raw formed body was hot-pressed at 1890° C. and a pressure of 20 MPa, to yield a SiC plate having a thickness of about 3 mm. Furthermore, the surface was ground with a diamond grindstone of #800, and polished with a diamond paste to set the Ra thereof to 0.008 μm. Furthermore, the surface was coated with a glass paste (G-5177, manufactured by Shoei Chemical Industries Co., Ltd.), and the temperature of the resultant was raised to 600° C. In this way, a SiO₂ layer having a thickness of 3 μm was formed.

Next, this plate was cut off into a disc having a diameter of 210 mm to prepare a plate formed body of the ceramic (ceramic substrate 11). This ceramic substrate was drilled to form through holes 35 for letting lifter pins 36 for a silicon wafer pass through, and bottomed holes 34 (diameter: 1.1 mm, and depth: 2 mm) for embedding thermocouples.

In this example, gutters having a width of 50 μm were formed until the gutters reached 30%, 60% and 90% of the thickness of the resistance heating elements, and the ceramic substrate, respectively, and the same gutters were formed until the depth of the gutters in the ceramic substrate was 2 μm.

### COMPARATIVE EXAMPLE 5

A ceramic heater was produced and the dispersion of the resistance value of its resistance heating elements was measured in the similar manner to Example 5 except that the depth of its gutters was set to 15% of the thickness of the resistance heating elements.

About the ceramic heaters according to Examples 5 to 6 and the ceramic heater according to Comparative Example 5, the dispersion of the resistance values before and after the trimming are described in Table 3.

The ceramic heaters obtained through the above-mentioned steps were evaluated on the basis of the following indexes.

(1) Warp of Substrate

The flatness degree was measured at 17 points in the ceramic substrate with a flatness degree measuring device (Nexiv Co.), and change in the flatness degree was examined. When no change was generated, it was judged that no warp was generated.

(2) Oxidation Resistance of Resistance Heating Elements

Each of the ceramic heaters was heated to 350° C. and was allowed to stand still for 2 weeks. The change ratio of the resistance value was then measured. The change ratio of the resistance value was calculated from the follow equation (1):

Change ratio (%) of the resistance value=[(the resistance value after the heating−the resistance value before the heating)/the resistance value before the heating]×100 (1)

(3) Drop in Strength of Substrate

A sample was prepared according to JIS R 1601, and the drop ratio of the strength thereof was measured.

About the strength of the sample, an Instron universal tester (4507 model, load cell: 500 kgf) was used to make a test in the atmosphere of 25 to 1000° C. temperature under the following conditions: cross head speed: 0.5 mm/minute, span length L: 30 mm, thickness of the test piece: 3.06 mm, and width of the test piece: 4.03 mm. The following calculating equation (1) was used to calculate the three-point bending strength σ (kgf/mm²) Values shown in Table 3 are bending strengths at 25° C.

$$\begin{matrix}Calculating equation ( 1 ) \\ σ = \frac{3 P L}{2 w {t}^{2}}\end{matrix}$$

TABLE 3

| | | Dispersion of | Dispersion of | | | |
|---|---|---|---|---|---|---|
| | | the resistance | the resistance | | | |
| | Depth of | value before | value after | Warp of the | Oxidation | Strength |
| | the gutter | trimming | trimming | Substrate | resistance | drop |
| | (%) | (%) | (%) | (%) | (%) | (%) |
| Example 5 | 30 | 7.1 | 4.2 | Not | 0.5 | 0 |
| | | | | generated | | |
| | 60 | 7.1 | 3.0 | Not | 0.5 | 0 |
| | | | | generated | | |
| | 90 | 7.4 | 1.5 | Not | 0.5 | 0 |
| | | | | generated | | |
| | 100 | 7.0 | 1.0 | Not | 0 | 1.7 |
| | | | | generated | | |
| | 100 or more | 7.4 | 1.0 | Not | 0 | 4.7 |
| | | | | generated | | |
| Example 6 | 30 | 11.1 | 6.0 | Not | 0.5 | 0 |
| | | | | generated | | |
| | 60 | 11.3 | 5.5 | Not | 0.5 | 0 |
| | | | | generated | | |
| | 90 | 11.0 | 5.0 | Not | 0.5 | 0 |
| | | | | generated | | |
| | 100 | 12.4 | 5.0 | Not | 0 | 1.0 |
| | | | | generated | | |
| | 100 or more | 11.6 | 4.2 | Not | 0 | 3.0 |
| | | | | generated | | |
| Comparative | 15 | 7.2 | 7.2 | Not | 2 | 0 |
| Example 5 | | | | generated | | |

As is evident from Table 3, it is understood that the dispersion of the resistance value cannot be suppressed when the depth of the formed gutters is less than 20% of the thickness of the resistance heating elements (Comparative Example 5).

As is evident from the results shown in Table 3, in Examples 5 to 6, the gutters were formed to have a depth of 20% or more of the thickness of the resistance heating elements; therefore, the dispersion of the resistance value can surely be suppressed. The substrate hardly warped and the strength hardly dropped.

It can be presumed that if the resistance heating elements remains on the bottom of the gutters, a slight change in the resistance value is caused. Thus, the gutters reaching the ceramic substrate are optimal.

### EXAMPLE 7

A ceramic heater 10 was produced in the similar manner to Example 5 except that the thickness of its resistance heating elements was set to 5 μm and gutters reaching its ceramic substrate were formed in the resistance heating elements.

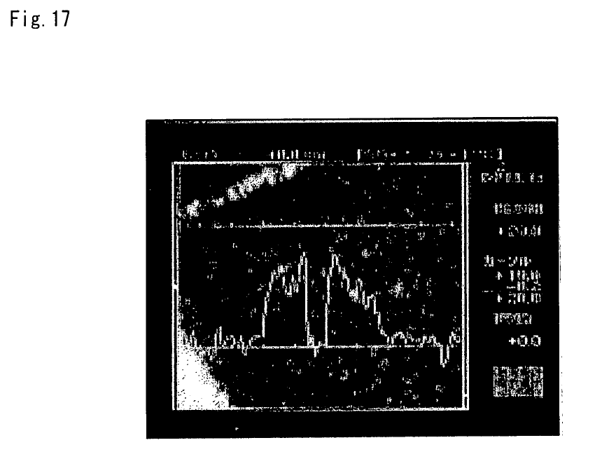

FIG. 17 is a graph showing the shape (position and height) of resistance heating element sections. It is understood from FIG. 17 that the gutters by trimming reached the ceramic substrate. The measurement was made with a laser displacement meter manufactured by Keyence Co.

### EXAMPLE 8

A ceramic heater was produced in the similar manner to Example 6 except that the thickness of its resistance heating elements was set to 5 μm and gutters reaching its ceramic substrate were formed in the resistance heating elements.

### EXAMPLE 9

A ceramic heater was produced and the dispersion of the resistance value of its resistance heating elements was measured in the similar manner to Example 5 except that the thickness of the resistance heating elements was set to 5 μm and trimming was performed a plurality of times perpendicularly to the direction in which electric current would be conducted to form gutters perpendicular to the direction in which the electric current would be conducted.

TABLE 4

| Resistance heating | | Resistance heating | | Resistance heating | | Resistance heating | | |
|---|---|---|---|---|---|---|---|---|
| element 12a | | element 12b | | element 12c | | element 12d | | Dispersion between |
| Average | | Average | | Average | | Average | | the resistance |
| value | Dispersion | value | Dispersion | value | Dispersion | value | Dispersion | heating elements |
| (Ω) | (%) | (Ω) | (%) | (Ω) | (%) | (Ω) | (%) | (%) |

Dispersion of the resistance value of each resistance heating element before trimming

| | | | | | | | | | |
|---|---|---|---|---|---|---|---|---|---|
| Example 7 | 535 | 11.6 | 547 | 7.0 | 540 | 7.4 | 548 | 12.4 | 2.4 |
| Example 8 | 540 | 10.0 | 536 | 8.0 | 545 | 7.0 | 547 | 11.5 | 2.0 |
| Example 9 | 541 | 11.0 | 535 | 8.0 | 544 | 8.0 | 547 | 14.5 | 2.2 |

Dispersion of the resistance value of each resistance heating element after trimming

| | | | | | | | | | |
|---|---|---|---|---|---|---|---|---|---|
| Example 7 | 581 | 4.2 | 581 | 1.0 | 580 | 1.7 | 578 | 5.0 | 0.5 |
| Example 8 | 580 | 4.0 | 581 | 3.0 | 580 | 1.0 | 580 | 1.5 | 0.2 |
| Example 9 | 580 | 10.0 | 581 | 7.0 | 581 | 7.0 | 580 | 10 | 0.2 |

A temperature adjustor (E5ZE, manufactured by Omron Co.) was fitted to each of the ceramic heaters produced in Examples 7 to 9 and they were evaluated about the following performances.

(1) Evenness of Temperature Distribution in Heating Face

A silicon wafer to which 17-point temperature measuring elements were fitted was used to measure distribution in the in-face temperature. The temperature distribution is indicated by the difference between the highest temperature and the lowest temperature when setting temperature was made to 200° C.

(2) Evenness of In-Face Temperature at Transitional Time

The distribution in the in-face temperature was measured when the temperature of each of the heaters was raised from room temperature to 130° C. The temperature distribution is indicated by the difference between the highest temperature and the lowest temperature.

(3) Overshooting Degree

The temperature of each heater was raised to 200° C., then the following was measured, that is: how much at most the temperature rise from 200° C. before the temperature arrives at a stationary temperature.

(4) Recovery Period

In the case where setting temperature was 140° C. and a silicon wafer of 25° C. was placed on the ceramic heater, the period until the temperature was recovered to 140° C. (recovery time) was measured.

The results are shown in Table 5.

TABLE 5

| | | Distribution | | |
|---|---|---|---|---|
| | Distribution in | in the in-face | | |
| | the in-face | temperature | Overshooting | Recovery |
| | temperature | at transitional | degree | time |
| | (° C.) | time (° C.) | (° C.) | (second) |
| Example 7 | 0.3 | 3.1 | 0.3 | 25 |
| Example 8 | 0.3 | 5.0 | 0.3 | 25 |
| Example 9 | 1 | 8.0 | 2 | 35 |

As is evident from the results shown in Table 4, the dispersion of the resistance value of the resistance heating elements 12a to 12d after the trimming was about 5% or less in each of the channels in Examples 7 and 8 (the dispersion was 1% in the example exhibiting the highest precision), and the in-face dispersion was as good as 0.5% or less. Moreover, the heating elements were not melted.

On the other hand, it was understood that in Example 9 the dispersion was 7% or more in each of the resistance heating elements, and the heating elements were melted.

As is also evident from the results shown in Table 5, in Examples 7 and 8, neither dispersion of the resistance value in each of the channels nor the dispersion of the resistance value between the channels after the trimming is generated. Thus, the in-face temperature evenness is superior at stationary time and transitional time. The resistance value is also even. Therefore, the temperature is easily controlled, the overshot temperature is low, and the recovery time is also short.

On the other hand, in Example 9, the resistance dispersion in each of the channels cannot be made small; therefore, the in-face temperature evenness is poor at stationary time and transitional time. Moreover, the temperature controllability is poor, the overshot temperature is also high, and the recovery time is also long.

In Example 9, the temperature cannot be controlled by the seven channels. It is therefore necessary to increase the number of the channels and vary applied electric power in order to control the temperature.

In Example 9, there was observed a case where a local rise in the resistance value was caused so that heat was excessively generated and some of the resistance heating elements were melted, whereby disconnection was caused.

### EXAMPLE 10

A ceramic heater 10 was produced in the similar manner to Example 5 except that: when its ceramic substrate was produced, the substrate was ground from both sides thereof with a diamond grindstone of #220 under a load of 1 kg/cm² and further polished with a diamond paste (particle diameter: 0.5 μm) and a polishing cloth so as to make the surface roughness Ra of the surface to 0.01 μm; and when its resistance heating elements were formed, the thickness of the resistance heating elements was set to 5 μm and gutters having a width of 50 μm were formed in the resistance heating elements so as to have a depth of 2 μm.

### EXAMPLE 11

A ceramic heater was produced in the similar manner to Example 6 except that: when its ceramic substrate was produced, the substrate was ground with a diamond grindstone of #800 and then polished with a diamond paste so as to make the surface roughness Ra of the surface to 0.008 μm; a glass paste (G-5177, manufactured by Shoei Chemical Industries Co., Ltd.) was applied onto the surface, the temperature thereof was raised to 600° C., a SiO₂ layer having a thickness of 3 μm was formed, and the surface was ground with the diamond grindstone of #800; and when its resistance heating elements were formed, the width of the resistance heating elements was set to 5 μm and gutters having a width of 50 μm were made in the resistance heating elements so as to have a depth of 2 μm.

About the ceramic heaters produced in Examples 10 and 11, the dispersion of the resistance value before the trimming and that after the trimming were measured according to the above-mentioned method.

The results are shown in Table 6.

TABLE 6

| Resistance heating | | Resistance heating | | Resistance heating | | Resistance heating | | |
|---|---|---|---|---|---|---|---|---|
| element 12a | | element 12b | | element 12c | | element 12d | | Dispersion between |
| Average | | Average | | Average | | Average | | the resistance |
| value | Dispersion | value | Dispersion | value | Dispersion | value | Dispersion | heating elements |
| (Ω) | (%) | (Ω) | (%) | (Ω) | (%) | (Ω) | (%) | (%) |

Dispersion of the resistance value of each resistance heating element before trimming

| | | | | | | | | | |
|---|---|---|---|---|---|---|---|---|---|
| Example 10 | 535 | 11.6 | 547 | 7.0 | 540 | 7.4 | 548 | 12.4 | 2.4 |
| Example 11 | 540 | 10.0 | 536 | 8.0 | 545 | 7.0 | 547 | 11.5 | 2.0 |

Dispersion of the resistance value of each resistance heating element after trimming

| | | | | | | | | | |
|---|---|---|---|---|---|---|---|---|---|
| Example 10 | 581 | 4.2 | 581 | 1.0 | 580 | 1.7 | 578 | 5.0 | 0.5 |
| Example 11 | 580 | 4.0 | 581 | 3.0 | 580 | 1.0 | 580 | 1.5 | 0.2 |

As is evident from the results shown in Table 6, the dispersion of the resistance value of the resistance heating elements 12a to 12d after the trimming was about 5% or less in each of the channels in Examples 10 and 11 (the dispersion was 1% in the example exhibiting the highest precision), and the in-face dispersion was as good as 0.5% or less. Moreover, the heating elements were not melted.

### EXAMPLE 12

A ceramic heater was produced in the similar manner to Example 5 except that: when its ceramic substrate was produced, both faces of the ceramic substrate were ground with a diamond grindstone of #220 under a load of 1 kg/cm² so as to make the surface roughness Ra to 0.6 μm; and when its resistance heating elements were formed, the thickness of the resistance heating elements was set to 5 μm and gutters having a width of 50 μm were formed in the resistance heating elements so as to have a depth of 2 μm.

### EXAMPLE 13

A ceramic heater was produced in the similar manner to Example 5 except that: when its ceramic substrate was produced, both faces of the ceramic substrate were ground with a diamond grindstone of #120 under a load of 1 kg/cm² so as to make the surface roughness Ra to 1.0 μm; and when its resistance heating elements were formed, the thickness of the resistance heating elements was set to 5 μm and gutters having a width of 50 μm were made in the resistance heating elements so as to have a depth of 2 μm.

### EXAMPLE 14

A ceramic heater was produced in the similar manner to Example 5 except that: when its ceramic substrate was produced, both faces of the ceramic substrate were ground with a diamond grindstone of #100 under a load of 1 kg/cm² so as to make the surface roughness Ra to 8.0 μm; and when its resistance heating elements were formed, the thickness of the resistance heating elements was set to 5 μm and gutters having a width of 50 μm were made in the resistance heating elements so as to have a depth of 2 μm.

### EXAMPLE 15

A ceramic heater was produced in the similar manner to Example 5 except that: when its ceramic substrate was produced, both faces of the ceramic substrate were ground with a diamond grindstone of #80 under a load of 1 kg/cm² so as to make the surface roughness Ra to 18.0 μm; and when its resistance heating elements were formed, the thickness of the resistance heating elements was set to 5 μm and gutters having a width of 50 μm were formed in the resistance heating elements so as to have a depth of 2 μm.

### COMPARATIVE EXAMPLE 6

A ceramic heater was produced in the similar manner to Example 5 except that: when its ceramic substrate was produced, both faces of the ceramic substrate were not ground; and when its resistance heating elements were formed, the thickness of the resistance heating elements was set to 5 μm and gutters having a width of 50 μm were made in the resistance heating elements so as to have a depth of 2 μm. The surface roughness Ra of the ceramic substrate at this time was 22.0 μm.

The ceramic heaters according to Examples 10 to 15 and Comparative Example 6 were evaluated on the basis of the following indexes. The results are shown in Table 7.

(1) Warp of Substrate

Change in the flatness was examined in the similar way of examining the ceramic heaters according to Examples 5 to 6 and the ceramic heater according to Comparative Example 5.

(2) Drop in Strength of Substrate

The strength drop ratio of the ceramic substrate was measured in the similar way of examining the ceramic heaters according to Examples 5 to 6 and the ceramic heater according to Comparative Example 5.

(3) Cooling Property

The temperature of each of the ceramic heater was raised to 140° C. and subsequently the time until the ceramic heater was cooled to 90° C. was measured. The coolant was air, and was sprayed at 0.01 m³/minute.

(4) Adhesiveness of Resistance Heating Elements

The heating element surface onto which laser was radiated was subjected to plating with Ni, and a pin was fixed thereto with solder to measure the tensile strength.

TABLE 7

| | | | Strength drop | | |
|---|---|---|---|---|---|
| | Surface | | of the | | Tensile |
| | roughness Ra | Warp of the | substrate | Cooling time | strength |
| | (μm) | substrate | (%) | (second) | (N/mm²) |
| Example 10 | 0.01 | Not generated | 0 | 100 | 72 |
| Example 11 | 0.0008 | Not generated | 0 | 110 | 72 |
| Example 12 | 0.6 | Not generated | 1.7 | 120 | 70 |
| Example 13 | 1.0 | Not generated | 4.7 | 120 | 68 |
| Example 14 | 8.0 | Not generated | 4.7 | 120 | 68 |
| Example 15 | 18.0 | Not generated | 5.0 | 180 | 65 |
| Comparative | 22.0 | Generated | 8.0 | 240 | 50 |
| Example 6 | | | | | |

Notes) Tensile strength: tensile strength of the resistance heating elements

As is evident from the results shown in Table 7, in Examples 10 to 15, the surface roughness Ra of the substrate is adjusted to 20 μm or less; therefore, drop in the strength of the ceramic substrate can be suppressed and warp is hardly generated in the ceramic substrate. It appears that this is because the ceramic substrate is not damaged more than necessity by the reflection of laser ray.

Furthermore, the cooling time is also shorter as the surface roughness Ra is smaller. The reason for this is presumed as follows: In the case where the surface roughness Ra is large, gutters are formed in the resistance heating elements and irregularities are generated; turbulence caused by the generation of the irregularities is further increased by irregularities in the surface of the ceramic substrate; consequently, heat-accumulated air is caused to remain.

### INDUSTRIALLY APPLICABILITY

As described above, according to the ceramic heater for a semiconductor producing/examining device of the first aspect of the present invention, the resistance dispersion thereof is hardly generated; therefore, the temperature in the heating face can be made even, in particular, at transitional time. Furthermore, the recovery time can be made short.

According to the ceramic heater for a semiconductor producing/examining device of the second present invention, the dispersion of the resistance value of its resistance heating element is hardly generated; therefore, the temperature in the heating face can be made even. Furthermore, its substrate is not damaged and the oxidation resistance of the heating elements is not deteriorated.

According to the ceramic heater for a semiconductor producing/examining device of the third aspect of the present invention, its ceramic substrate has a surface roughness Ra of 20 μm or less; therefore, the strength of the ceramic substrate does not drop and the ceramic substrate does not warp. Furthermore, the adhesive strength of the heating elements irradiated with laser does not drop. Moreover, an improvement in the cooling speed can also be expected.

By adjusting the resistance dispersion to 5% or less in the ceramic heaters for a semiconductor producing/examining device of the second and third aspects of the present invention, the ceramic heaters can be made so as to have superior temperature evenness in their heating face and their heating elements can be prevented from being heated and melted. Furthermore, the number of their channels can be reduced, and the in-face temperature evenness can be improved at transitional time. The recovery time can also be made short.

1. A ceramic heater for a semiconductor producing/examining device, comprising:
ceramic substrate; and a resistance heating element formed on a surface of said ceramic substrate or inside said ceramic substrate,
wherein
the dispersion of the resistance value of said resistance heating element to the average resistance value thereof is 25% or less.

2. The ceramic heater for a semiconductor producing/examining device according to claim 1,
wherein
said resistance heating element comprises a resistance heating element having a repeated pattern of a winding line.

3. The ceramic heater for a semiconductor producing/examining device according to claim 1,
wherein
said resistance heating element comprises a resistance heating element formed by combining a concentric circular pattern or a spiral pattern with a repeated pattern of a winding line.

4. The ceramic heater for a semiconductor producing/examining device according to any of claims 1 to 3,
wherein
said ceramic substrate has a thickness of 25 mm or less.

5. The ceramic heater for a semiconductor producing/examining device according to any of claims 1 to 4,
wherein
said ceramic substrate has a porosity of 5% or less.

6. The ceramic heater for a semiconductor producing/examining device according to any of claims 1 to 5,
wherein
said ceramic substrate has a diameter of 200 mm or more.

7. A ceramic heater for a semiconductor producing/examining device, comprising:
a ceramic substrate; and a resistance heating element formed on said ceramic substrate,
wherein
a gutter or an incision is formed in said resistance heating element, and
said gutter has a depth of 20% or more of the thickness of the resistance heating element.

8. A ceramic heater for a semiconductor producing/examining device, comprising:
a ceramic substrate and a resistance heating element formed on said ceramic substrate,
wherein
a gutter or an incision is formed in said resistance heating element, and
the resistance heating element-formed face of said ceramic substrate has a surface roughness of R≦20 μm.

9. The ceramic heater for a semiconductor producing/examining device according to claim 7 or 8,
wherein
the dispersion of the resistance value of said resistance heating element to the average resistance value thereof is 5% or less.

10. The ceramic heater for a semiconductor producing/examining device according to any of claims 7 to 9,
wherein
said gutter is formed along the direction in which electric current flows in said resistance heating element.

11. The ceramic heater for a semiconductor producing/examining device according to any of claims 7 to 10,
wherein
said gutter or incision is formed by laser ray.
